(19) United States
(12) Patent Application Publication
(10) Pub. No.: US 2019/0355058 A1
(43) Pub. Date: Nov. 21, 2019

(54) METHOD AND APPARATUS FOR PROCESSING CREDIT SCORE REAL-TIME ADJUSTMENT, AND PROCESSING SERVER

(71) Applicant: TENCENT TECHNOLOGY (SHENZHEN) COMPANY LTD, Shenzhen (CN)

(72) Inventor: Yin Gang HUANG, Shenzhen (CN)

(73) Assignee: TENCENT TECHNOLOGY (SHENZHEN) COMPANY LTD, Shenzhen (CN)

(21) Appl. No.: 16/525,980

(22) Filed: Jul. 30, 2019

Related U.S. Application Data
(63) Continuation of application No. PCT/CN2018/082277, filed on Apr. 9, 2018.

(30) Foreign Application Priority Data
Apr. 14, 2017 (CN) 201710245134.3

(51) Int. Cl. G06Q 40/02; G06N 7/00

(52) U.S. Cl. CPC G06Q 40/025; G06N 7/005

(57) ABSTRACT

A real-time credit score adjustment approach that determines, according to a probability distribution for a credit adjustment score corresponding to behavior types and benchmark scores, a target probability distribution by using the credit score of the user as a target reference score, the target probability distribution including a probability corresponding to adjustment from the credit score of the user to each credit adjustment score; and determines an adjusted credit score according to the probability that corresponds to the adjustment from the credit score of the user to each credit adjustment score and that is indicated by the probability distribution. The credit score of the user can be adjusted in real time, thereby improving timeliness of adjusting a credit score, and improving accuracy of subsequent application based on the credit score.

### RELATED APPLICATION

This application is a continuation of PCT/CN2018/082277 filed Apr. 9, 2018, which claims priority to Chinese Patent Application No. 201710245134.3, entitled “METHOD AND APPARATUS FOR PROCESSING CREDIT SCORE REAL-TIME ADJUSTMENT, AND PROCESSING SERVER” filed with the Chinese Patent Office on Apr. 14, 2017, the entirety of both being incorporated herein by reference.

### BACKGROUND

### Field

Methods and apparatuses consistent with embodiments of this disclosure relate to the field of data processing technologies, and specifically, to processing of credit score real-time adjustment.

### Related Art

Credit reporting is a reflection of a credit rating of a user, and specifically, the credit rating of the user may be represented in a form of a credit score. The credit reporting is widely used in fields such as credit and loan, sharing economy, user comments, and information recommendation. In addition, with continuous development of technologies, application fields of the credit reporting are expanding. Therefore, how to optimize an information processing manner about the credit reporting is always a concern researched by a person skilled in the art.

In the information processing approaches relating to credit reporting, adjustment of a credit score of a user is relatively basic. In a conventional credit score adjustment manner, generally, a credit scoring model is used to adjust a credit score of a user that is estimated last time, to update the credit score of the user.

However, the conventional credit score adjustment manner is generally implemented by a network side server periodically. Such a periodic credit score adjustment manner has a problem of poor timeliness. Specifically, a result of the conventional credit score adjustment manner is, for example, when using a credit score of a user to decide an amount of credit of the user, a credit department can use only a credit score of the user that is determined in a last period. If a credit score is significantly damaged in credit information of the user in a current period, there is a derivation in the amount of credit of the user that is decided by using the credit score of the user in the last period.

### SUMMARY

In view of this, certain embodiments of this disclosure provide a method and an apparatus for processing credit score real-time adjustment, and a processing server, to improve timeliness of adjusting a credit score.

In order to achieve the foregoing objective, certain embodiments of this disclosure provide the following technical solutions:

According to a first aspect, this application provides a method for processing credit score real-time adjustment, applied to a processing server, and including: obtaining behavior information of a user from at least one remote platform; determining a target behavior type corresponding to the behavior information; obtaining a credit score of the user; determining, according to a probability distribution for a credit adjustment score corresponding to each behavior type and each benchmark score, a target probability distribution by using the credit score of the user as a target reference score, the target probability distribution being a probability distribution for a credit adjustment score corresponding to the target behavior type and the target reference score, and the target probability distribution including a probability corresponding to adjustment from the credit score of the user to each credit adjustment score; and determining an adjusted credit score according to the probability that corresponds to the adjustment from the credit score of the user to each credit adjustment score and that is indicated by the probability distribution.

In a possible implementation of the first aspect, each credit adjustment score to which the credit score of the user is capable of being adjusted is in a set adjustment range corresponding to the credit score of the user.

In a possible implementation of the first aspect, the determining an adjusted credit score according to the probability that corresponds to the adjustment from the credit score of the user to each credit adjustment score and that is indicated by the probability distribution includes: randomly selecting an adjusted credit score from the credit adjustment scores according to the probability that corresponds to the adjustment from the credit score of the user to each credit adjustment score and that is indicated by the probability distribution.

In a possible implementation of the first aspect, the randomly selecting an adjusted credit score from the credit adjustment scores according to the probability that corresponds to the adjustment from the credit score of the user to each credit adjustment score and that is indicated by the probability distribution includes:

generating a random number;

determining a probability that corresponds to the random number in the probability distribution, to obtain a target probability; and

using a credit score that corresponds to the target probability in the target probability distribution as the adjusted credit score.

In a possible implementation of the first aspect, the determining a probability that corresponds to the random number in the probability distribution, to obtain a target probability includes:

determining a probability range corresponding to a probability of each credit adjustment score in the target probability distribution, for each credit adjustment score, the probability range corresponding to the probability of the credit adjustment score being a range corresponding to an upper probability limit of a previous credit adjustment score of the credit adjustment score to a sum of the upper probability limit and the probability of the credit adjustment score; and

determining a probability of a credit adjustment score corresponding to a probability range to which the random number belongs, to obtain the target probability.

In a possible implementation of the first aspect, the method further includes:

using each credit score in a credit score range as a benchmark score; and

updating, according to the behavior information of the user, a probability corresponding to each credit adjustment score to which each benchmark score in a case of each behavior type is capable of being adjusted, and obtaining and recording a probability distribution for the credit adjustment score corresponding to each behavior type and each benchmark score.

In a possible implementation of the first aspect, the updating, according to the behavior information of the user, a probability corresponding to each credit adjustment score to which each benchmark score in a case of each behavior type is capable of being adjusted includes:

using any behavior type as a first behavior type, and using any benchmark score in a case of the first behavior type as a first benchmark score;

when it is found, through monitoring, that there is a behavior feedback result for an executed behavior of the first behavior type, determining, in historically executed behaviors of all users corresponding to the first behavior type, a historically executed behavior corresponding to each credit adjustment score corresponding to the first benchmark score;

determining, for each credit adjustment score, a reward value of each historically executed behavior corresponding to the credit adjustment score, a value of the reward value including a first value and a second value, and a credit reporting level represented by the first value being higher than a credit reporting level represented by the second value; and determining, for each credit adjustment score according to the reward value of each historically executed behavior corresponding to the credit adjustment score, a probability corresponding to adjustment from the first benchmark score to the credit adjustment score in a case of the first behavior type, to obtain a probability corresponding to adjustment from the first benchmark score to each credit adjustment score in the case of the first behavior type.

In a possible implementation of the first aspect, the determining, for each credit adjustment score according to the reward value of each historically executed behavior corresponding to the credit adjustment score, a probability corresponding to adjustment from the first benchmark score to the credit adjustment score in a case of the first behavior type includes:

determining, for each credit adjustment score according to the reward value of each historically executed behavior corresponding to the credit adjustment score, earnings corresponding to the adjustment from the first benchmark score to the credit adjustment score, to obtain earnings corresponding to the credit adjustment score; and

determining, for each credit adjustment score according to the earnings corresponding to the credit adjustment score and total earnings corresponding to all credit adjustment scores, the probability corresponding to adjustment from the first benchmark score to the credit adjustment score in the case of the first behavior type.

In a possible implementation of the first aspect, the determining, for each credit adjustment score according to the reward value of each historically executed behavior corresponding to the credit adjustment score, earnings corresponding to the adjustment from the first benchmark score to the credit adjustment score includes:

determining, for each credit adjustment score according to the reward value of each historically executed behavior corresponding to the credit adjustment score and a total quantity of users, historical earnings corresponding to the credit adjustment score; and determining, for each credit adjustment score according to a total quantity of times that the first benchmark score is historically adjusted to the credit adjustment score and the total quantity of users, estimated future earnings corresponding to the credit adjustment score; and

determining a sum of historical earnings and estimated future earnings corresponding to a same credit adjustment score, as earnings corresponding to adjustment from the first benchmark score to the credit adjustment score.

In a possible implementation of the first aspect, the determining, for each credit adjustment score according to the reward value of each historically executed behavior corresponding to the credit adjustment score, a probability corresponding to adjustment from the first benchmark score to the credit adjustment score in a case of the first target behavior type includes:

determining, for each credit adjustment score, a proportion that the reward value of each historically executed behavior corresponding to the credit adjustment score is the first value, to obtain a proportion that a reward value corresponding to the credit adjustment score is the first value; and

dividing, for each credit adjustment score, the proportion that the reward value corresponding to the credit adjustment score is the first value by a sum of proportions that a reward value corresponding to each credit adjustment score is the first value, to obtain the probability corresponding to the adjustment from the first benchmark score to the credit adjustment score in the case of the first behavior type.

In a possible implementation of the first aspect, the determining a behavior type corresponding to the behavior information includes:

matching the behavior information with a preset behavior description corresponding to each behavior type, to determine whether a behavior type matching the behavior information exists; and

if a behavior type matching the behavior information exists, determining the behavior type matching the behavior information; or

if no behavior type matching the behavior information exists, identifying, according to each preset behavior recognition model, a behavior type corresponding to the behavior information.

In a possible implementation of the first aspect, the determining a behavior type corresponding to the behavior information includes:

matching the behavior information with a preset behavior description corresponding to each behavior type, to determine a behavior type matching the behavior information; or

identifying, according to each preset behavior recognition model, a behavior type corresponding to the behavior information.

According to a second aspect, this application provides an apparatus for processing credit score real-time adjustment, including:

a behavior information obtaining module, configured to obtain behavior information of a user;

a behavior type determining module, configured to determine a target behavior type corresponding to the behavior information;

a user credit score obtaining module, configured to obtain a credit score of the user;

a probability distribution determining module, configured to determine, according to a probability distribution for a credit adjustment score corresponding to each behavior type and each benchmark score, a target probability distribution by using the credit score of the user as a target reference score, the target probability distribution being a probability distribution for a credit adjustment score corresponding to the target behavior type and the target reference score, and the target probability distribution including a probability corresponding to adjustment from the credit score of the user to each credit adjustment score; and

a credit score adjustment module, configured to determine an adjusted credit score according to the probability that corresponds to the adjustment from the credit score of the user to each credit adjustment score and that is indicated by the probability distribution.

In a possible implementation of the second aspect, each credit adjustment score to which the credit score of the user is capable of being adjusted is in a set adjustment range corresponding to the credit score of the user.

In a possible implementation of the second aspect, that the credit score adjustment module is configured to determine an adjusted credit score according to the probability that corresponds to the adjustment from the credit score of the user to each credit adjustment score and that is indicated by the probability distribution specifically includes:

randomly select an adjusted credit score from the credit adjustment scores according to the probability that corresponds to the adjustment from the credit score of the user to each credit adjustment score and that is indicated by the probability distribution.

In a possible implementation of the second aspect, that the credit score adjustment module is configured to randomly select an adjusted credit score from the credit adjustment scores according to the probability that corresponds to the adjustment from the credit score of the user to each credit adjustment score and that is indicated by the probability distribution specifically includes:

generate a random number;

determine a probability that corresponds to the random number in the probability distribution, to obtain a target probability; and

use a credit score that corresponds to the target probability in the target probability distribution as the adjusted credit score.

In a possible implementation of the second aspect, that the credit score adjustment module is configured to determine a probability that corresponds to the random number in the probability distribution, to obtain a target probability includes:

determine a probability range corresponding to a probability of each credit adjustment score in the target probability distribution, for each credit adjustment score, the probability range corresponding to the probability of the credit adjustment score being a range corresponding to an upper probability limit of a previous credit adjustment score of the credit adjustment score to a sum of the upper probability limit and the probability of the credit adjustment score; and

determine a probability of a credit adjustment score corresponding to a probability range to which the random number belongs, to obtain the target probability.

In a possible implementation of the second aspect, the apparatus further includes:

a benchmark score selection module, configured to use each credit score in a credit score range as a benchmark score; and

a probability distribution update module, configured to update, according to the behavior information of the user, a probability corresponding to each credit adjustment score to which each benchmark score in a case of each behavior type is capable of being adjusted, and obtain and record a probability distribution for the credit adjustment score corresponding to each behavior type and each benchmark score.

In a possible implementation of the second aspect, that the probability distribution update module is configured to update, according to the behavior information of the user, a probability corresponding to each credit adjustment score to which each benchmark score in a case of each behavior type is capable of being adjusted includes:

use any behavior type as a first behavior type, and use any benchmark score in a case of the first behavior type as a first benchmark score;

when it is found, through monitoring, that there is a behavior feedback result for an executed behavior of the first behavior type, determine, in historically executed behaviors of all users corresponding to the first behavior type, a historically executed behavior corresponding to each credit adjustment score corresponding to the first benchmark score;

determine, for each credit adjustment score, a reward value of each historically executed behavior corresponding to the credit adjustment score, a value of the reward value including a first value and a second value, and a credit reporting level represented by the first value being higher than a credit reporting level represented by the second value; and

determine, for each credit adjustment score according to the reward value of each historically executed behavior corresponding to the credit adjustment score, a probability corresponding to adjustment from the first benchmark score to the credit adjustment score in a case of the first behavior type, to obtain a probability corresponding to adjustment from the first benchmark score to each credit adjustment score in the case of the first behavior type.

In a possible implementation of the second aspect, that the probability distribution update module is configured to determine, for each credit adjustment score according to the reward value of each historically executed behavior corresponding to the credit adjustment score, a probability corresponding to adjustment from the first benchmark score to the credit adjustment score in a case of the first behavior type includes:

determine, for each credit adjustment score according to the reward value of each historically executed behavior corresponding to the credit adjustment score, earnings corresponding to the adjustment from the first benchmark score to the credit adjustment score, to obtain earnings corresponding to the credit adjustment score; and

determine, for each credit adjustment score according to the earnings corresponding to the credit adjustment score and total earnings corresponding to all credit adjustment scores, the probability corresponding to adjustment from the first benchmark score to the credit adjustment score in the case of the first behavior type.

In a possible implementation of the second aspect, that the probability distribution update module is configured to determine, for each credit adjustment score according to the reward value of each historically executed behavior corresponding to the credit adjustment score, earnings corresponding to the adjustment from the first benchmark score to the credit adjustment score includes:

determine, for each credit adjustment score according to the reward value of each historically executed behavior corresponding to the credit adjustment score and a total quantity of users, historical earnings corresponding to the credit adjustment score; and determine, for each credit adjustment score according to a total quantity of times that the first benchmark score is historically adjusted to the credit adjustment score and the total quantity of users, estimated future earnings corresponding to the credit adjustment score; and

determine a sum of historical earnings and estimated future earnings corresponding to a same credit adjustment score, as earnings corresponding to adjustment from the first benchmark score to the credit adjustment score.

In a possible implementation of the second aspect, that the probability distribution update module is configured to determine, for each credit adjustment score according to the reward value of each historically executed behavior corresponding to the credit adjustment score, a probability corresponding to adjustment from the first benchmark score to the credit adjustment score in a case of the first target behavior type includes:

determine, for each credit adjustment score, a proportion that the reward value of each historically executed behavior corresponding to the credit adjustment score is the first value, to obtain a proportion that a reward value corresponding to the credit adjustment score is the first value; and

divide, for each credit adjustment score, the proportion that the reward value corresponding to the credit adjustment score is the first value by a sum of proportions that a reward value corresponding to each credit adjustment score is the first value, to obtain the probability corresponding to the adjustment from the first benchmark score to the credit adjustment score in the case of the first behavior type.

In a possible implementation of the second aspect, that the behavior type determining module is configured to determine a behavior type corresponding to the behavior information specifically includes:

match the behavior information with a preset behavior description corresponding to each behavior type, to determine whether a behavior type matching the behavior information exists; and

if a behavior type matching the behavior information exists, determine the behavior type matching the behavior information; or

if no behavior type matching the behavior information exists, identify, according to each preset behavior recognition model, a behavior type corresponding to the behavior information.

In a possible implementation of the second aspect, that the behavior type determining module is configured to determine a behavior type corresponding to the behavior information specifically includes:

match the behavior information with a preset behavior description corresponding to each behavior type, to determine a behavior type matching the behavior information; or

identify, according to each preset behavior recognition model, a behavior type corresponding to the behavior information.

According to a third aspect, this application provides a processing server, including the apparatus for processing credit score real-time adjustment according to any possible implementation of the second aspect.

According to a fourth aspect, this application provides a processing server, including a processor and a memory,

the memory being configured to store program code and transmit the program code to the processor; and

the processor being configured to perform the method for processing credit score real-time adjustment according to any possible implementation of the first aspect according to an instruction in the program code.

According to a fifth aspect, this application provides a storage medium, configured to store program code, the program code being used for performing the method for processing credit score real-time adjustment according to any possible implementation of the first aspect.

According to a sixth aspect, this application provides a computer program product including instructions, the computer program product, when run on a computer, causing the computer to perform the method for processing credit score real-time adjustment according to any possible implementation of the first aspect.

Based on the foregoing technical solutions, in certain aspects of this disclosure, the processing server may obtain the behavior information of the user; determine the target behavior type corresponding to the behavior information; obtain the credit score of the user; determine, according to the probability distribution for the credit adjustment score corresponding to each behavior type and each benchmark score, the target probability distribution by using the credit score of the user as the target reference score, the target probability distribution being a probability distribution for a credit adjustment score corresponding to the target behavior type and the target reference score, and the target probability distribution including a probability corresponding to adjustment from the credit score of the user to each credit adjustment score; and determine the adjusted credit score according to the probability that corresponds to the adjustment from the credit score of the user to each credit adjustment score and that is indicated by the probability distribution. It can be learned that, certain aspects of this disclosure do not relate to input of multidimensional information as a credit scoring model. Instead, the obtained target behavior type of the behavior information is only determined, and according to the target behavior type, the credit score of the user, and the probability distribution for the credit adjustment score corresponding to each behavior type and each benchmark score, the probability of the adjustment from the credit score of the user to each credit adjustment score is determined, so that a credit score adjustment result obtained according to the probability is more targeted, and a scenario of monitoring the credit score adjustment is more applicable for a single behavior. That is, the credit score of the user is adjusted in real time based on the behavior information of the user that is obtained in real time, thereby improving timeliness of adjusting a credit score.

### BRIEF DESCRIPTION OF THE DRAWINGS

To describe the technical solutions in certain aspects of this disclosure or in the existing technology more clearly, the following briefly describes the accompanying drawings required for describing the embodiments or the existing technology. The accompanying drawings in the following description show merely aspects of embodiments, and a person of ordinary skill in the art may still derive other drawings from these accompanying drawings without creative efforts.

FIG. 1 is a schematic architectural diagram of a system for processing credit score real-time adjustment according to aspects of certain embodiments;

FIG. 2 is a signaling flowchart of a method for processing credit score real-time adjustment according to aspects of certain embodiments;

FIG. 3 is a schematic description diagram of a behavior type according to aspects of certain embodiments;

FIG. 4 is a schematic diagram of a probability distribution according to aspects of certain embodiments;

FIG. 5 is another schematic diagram of a probability distribution according to aspects of certain embodiments;

FIG. 6 is a flowchart of a probability distribution adjustment method according to aspects of certain embodiments;

FIG. 7 is another flowchart of a probability distribution adjustment method according to aspects of certain embodiments;

FIG. 8 is a schematic application diagram according to aspects of certain embodiments;

FIG. 9 is a structural block diagram of an apparatus for processing credit score real-time adjustment according to aspects of certain embodiments;

FIG. 10 is another structural block diagram of an apparatus for processing credit score real-time adjustment according to aspects of certain embodiments; and

FIG. 11 is a structural block diagram of hardware of a processing server according to aspects of certain embodiments.

### DESCRIPTION OF EMBODIMENTS

The following clearly and completely describes the technical solutions in certain aspects of this disclosure with reference to the accompanying drawings. Obviously, the described embodiments are only some embodiments. All other embodiments obtained by a person of ordinary skill in the art based on the disclosed embodiments shall fall within the protection scope of the present disclosure.

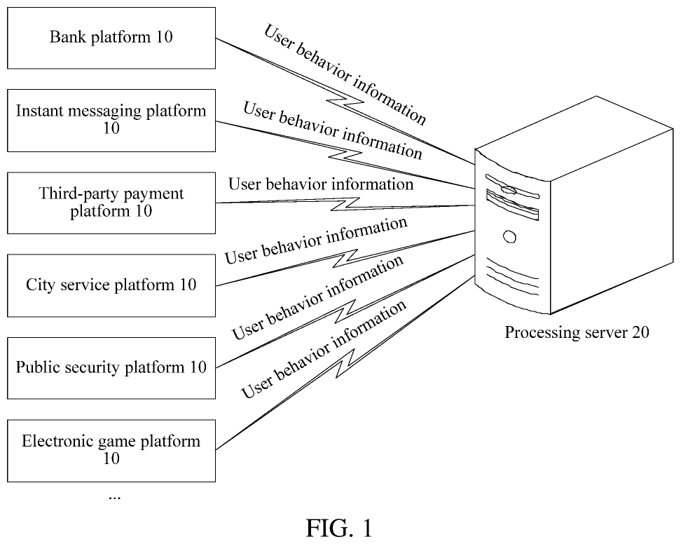

FIG. 1 is a schematic architectural diagram of a system for processing credit score real-time adjustment according to aspects of certain embodiments. As shown in FIG. 1, the system may include at least one user behavior information source 10 and a processing server 20.

In the system, the user behavior information source 10 refers to a platform for generating user behavior information, such as a bank platform, an instant messaging platform, a third-party payment platform, a city service platform, a public security platform, and an electronic game platform that are shown in FIG. 1. Such platforms typically include at least one database with information relating to behaviors of individuals.

Optionally, the bank platform correspondingly generates information about a user behavior related to a bank service, such as a deposit, a withdrawal, and a payment of a user in a bank.

The instant messaging platform correspondingly generates information about a user behavior related to an instant messaging service, for example, sharing, by a user, a moment (such as sharing a chat message, a comment, and a social circle moment) on the instant messaging platform.

The third-party payment platform correspondingly generates information about a user behavior related to a third-party payment service, such as a deposit, a withdrawal, and a payment on the third-party payment platform for an electronic commerce transaction of a user.

The city service platform correspondingly generates information about a user behavior related to a city service, such as payment of utilities, gas expenses, a property management fee, and a waste disposal fee.

The public security platform correspondingly generates information about a user behavior related to public security affairs such as an unlawful act and a delinquent act of a user.

The electronic game platform correspondingly generates information about a user behavior related to an electronic gaming service such as a bot and a chat of a user in a game.

It should be noted that, a form of the user behavior information source 10 is optional, and another form of user behavior information source may be expanded or be replaced within this embodiment with reference to an actual situation. The another form of user behavior information source 10 is, for example, a traffic management platform and various types of civil affairs platforms (for example, a platform related to a civil affair such as marriage management and family planning). In addition, during specific use, at least one user behavior information source 10 may be selected and used in this embodiment.

Optionally, the user behavior information generated by the user behavior information source 10 may be generated by the user by using a client to perform online interaction with the user behavior information source 10, for example, a user behavior information source in a form of an instant messaging platform or a third-party payment platform. Certainly, the user behavior information generated by the user behavior information source 10 may also be generated offline by the user in a service place corresponding to the user behavior information source, for example, a user behavior information source in a form of a city service platform (corresponding to offline payment of utilities, gas expenses, and a property management fee and then uploading to a network side) and a public security platform (corresponding to offline penalties of an unlawful act and a delinquent act and then uploading to a network side). Obviously, if sufficient or even all user behavior information sources support online interaction, in this embodiment, the user behavior information may be generated exactly in a manner of online interaction between a client and the user behavior information source 10.

Optionally, in this embodiment, different forms of user behavior information sources 10 may be integrated with each other. For example, the instant messaging platform is integrated with a third-party payment function, a city service entry, and the like. Optionally, different forms of user behavior information sources 10 may be independent from each other, and the different forms of user behavior information sources 10 may communicate with the processing server 20 by using respective interfaces.

The processing server 20 is a service device that is disposed on a network side and that processes information in this embodiment. The processing server 20 may be implemented by using a single server or a server cluster including a plurality of servers. In addition, the processing server 20 may interact with each user behavior information source 10, to monitor newly generated behavior information of each user.

Optionally, the processing server 20 may be a service device that is part of a platform of a user behavior information source. For example, the processing server 20 may be a service device that processes credit reporting information and that is of the instant messaging platform. The processing server 20 can collect user behavior information generated by a platform to which the processing server 20 belongs, and can monitor, by using an interface of another user behavior information source (where the another user behavior information source is not considered as a user behavior information source to which the processing server belongs), user behavior information generated by the another user behavior information source.

Optionally, the processing server 20 may be independent from each user behavior information source 10. The processing server 20 can monitor, by using an interface of each user behavior information source 10, user behavior information generated by each user behavior information source 10.

In the system shown in FIG. 1, the processing server 20 may obtain behavior information of a user by using various forms of user behavior information source 10. When obtain new behavior information of the user, the processing server 20 may adjust, according to the behavior information, a credit score of the user in real time online, thereby improving timeliness of adjusting the credit score of the user.

It should be noted that, compared with an existing conventional means of using a credit scoring model to adjust a credit score of a user, in this embodiment, both timing and a processing means of adjusting the credit score are different.

That is, the existing conventional means of using the credit scoring model to adjust the credit score of the user is implemented periodically, but in this embodiment, the credit score of the user can be adjusted in real time based on obtained new behavior information of the user.

Further, for the processing means of adjusting the credit score, there is a difference between this aspect and the existing conventional means. That is, the existing conventional means is: collecting update statuses in dimensions such as basic personal information of a user, bank credit information, personal payment information, and a personal asset status in a current period, and then importing latest information in the dimensions into a credit scoring model as input, to calculate a new credit score of the user by using a credit scoring model, thereby determining a credit score of the user in the current period. Therefore, even though the conventional means is used to adjust the credit score of the user in real time adjustment, a direction of the adjustment is: when it is monitored in real time that information in dimensions such as basic personal information of a user, bank credit information, personal payment information, and a personal asset status is updated, and importing latest information in the dimensions into a credit scoring model as input, to calculate a new credit score of the user by using a credit scoring model.

However, such a conventional means of adjusting the credit score relates to input of multidimensional information to the credit scoring model. In a scenario of adjusting the credit score in real time, a user behavior monitored at a time generally does not cover the multidimensional information. Therefore, the existing conventional means of adjusting the credit score in real time is not application, and a new manner of processing credit score adjustment needs to be creatively proposed.

Based on this, for the manner of processing credit score adjustment used in this embodiment, a specific processing means needs to be creatively improved in addition to changing the timing of adjusting the credit score to timing of adjusting the new behavior information of the user in real time. With reference to the system shown in FIG. 1, The following describes a signaling procedure in a method for processing credit score real-time adjustment according to aspects of certain embodiments.

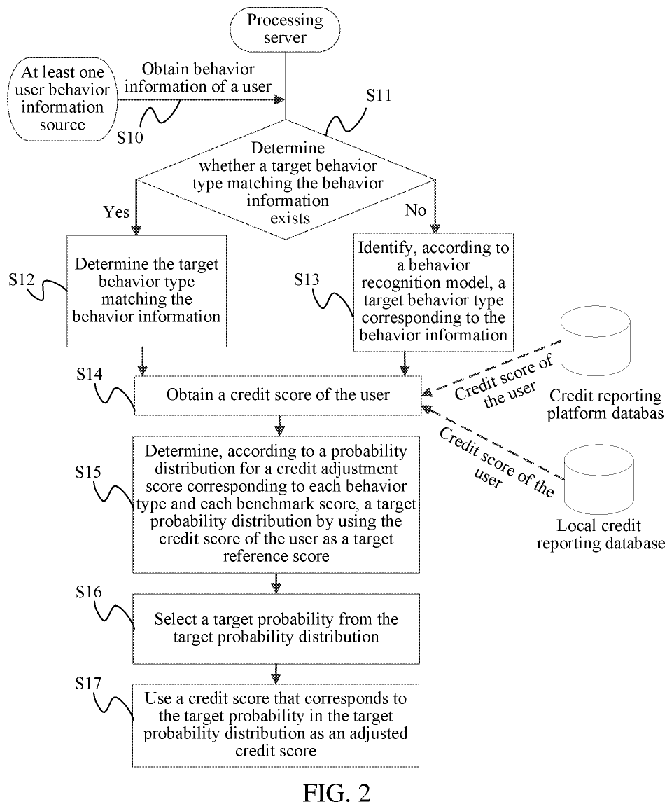

FIG. 2 is a signaling flowchart of a method for processing credit score real-time adjustment according to aspects of certain embodiments. In an implementation of this embodiment, the method for processing credit score real-time adjustment may be applied to a processing server. Referring to FIG. 2, the procedure may include the following steps.

Step S10. The processing server obtains behavior information of a user.

Optionally, the processing server may obtain the behavior information of the user by using various forms of user behavior information sources shown in FIG. 1. When the user behavior information sources generate new user behavior information (where the user behavior information may be considered as an abbreviation of the behavior information of the user, and relates to new behavior information of any user), the processing server may obtain the newly generated user behavior information based on reporting by the user behavior information sources or automatic query by the processing server to the user behavior information source. One piece of user behavior information obtained by the processing server generally corresponds to one behavior of a user. Specifically, the user behavior information may include a user identifier (a user account, a user ID number, or the like) indicating the user to which the behavior belongs and description content of the behavior.

Step S11. The processing server matches the behavior information with a preset behavior description corresponding to each behavior type, to determine whether a target behavior type matching the behavior information exists, and if a target behavior type matching the behavior information exists, perform step S12; or if no target behavior type matching the behavior information exists, perform step S13.

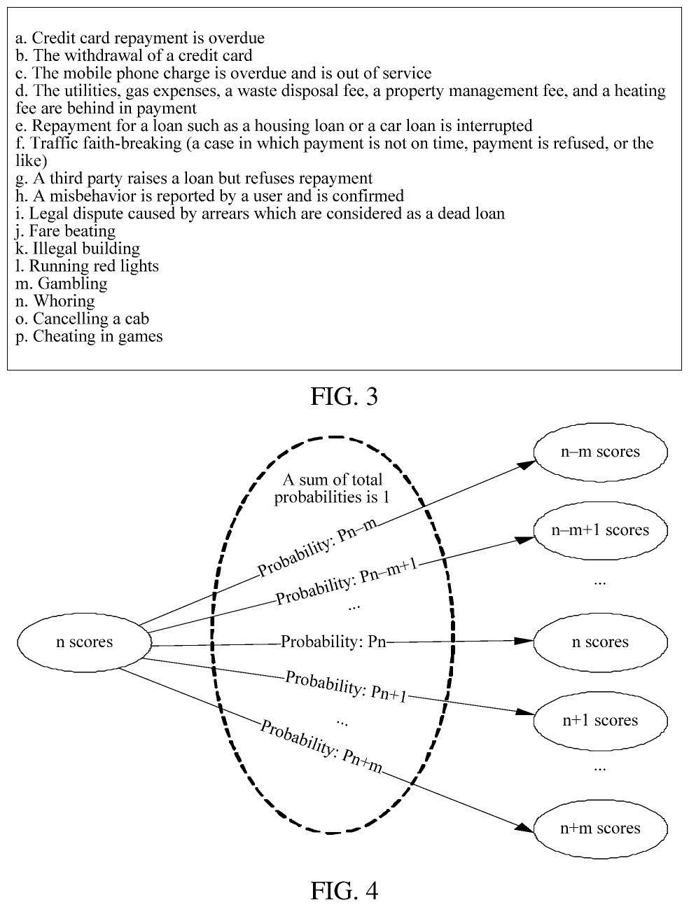

The target behavior type may be a behavior type matching the behavior information of the user. Optionally, in this embodiment, a behavior description (including a behavior description positively affecting each behavior type during the user credit reporting and/or a behavior description negatively affecting each behavior type during the user credit reporting) affecting each behavior type during user credit reporting may be preset. It should be noted that the preset behavior description of each behavior type may indicate behavior information affecting the user credit reporting. Specifically, after obtaining behavior information of a user, the processing server may first match the behavior information with the preset behavior description corresponding to each behavior type, and output a target behavior type corresponding to the behavior information. For ease of understanding each behavior type affecting the user credit reporting, FIG. 3 shows some preset behavior types, and reference may be made thereto.

It should be noted that there are various pieces of behavior information of the user. In this embodiment, it is possible that not behavior descriptions of all behavior types can be preset. It should be implemented that, if no target behavior type corresponding to the obtained behavior information is matched according to the preset behavior description corresponding to each behavior type, step S13 may be performed, to identify the behavior information by using each preset behavior recognition model.

Step S12. The processing server determines the target behavior type matching the behavior information.

Step S13. The processing server identifies, according to each preset behavior recognition model, a target behavior type corresponding to the behavior information.

Optionally, each type of behavior recognition model may be obtained by using corresponding positive and negative samples through training based on a machine learning algorithm. For example, the preset behavior recognition model may include: a child presentation behavior recognition model (correspondingly identifying a behavior of a user presenting a child, for example, identifying a moment shared by the user on an instant messaging platform for presenting a child), a love behavior recognition model (correspondingly identifying a love-related behavior of a user, for example, identifying a moment that is related to love and that is shared by the user on an instant messaging platform), and a marriage behavior recognition model (correspondingly identifying a marriage-related behavior of a user, identifying a moment that is related to marriage and that is shared by the user on an instant messaging platform). Generally, it may be considered that if the user falls in love, gets married, and gives birth to a child, it helps improve stability and responsibility of the user. Therefore, falling in love, getting married, and giving birth to a child affect credit reporting of the user. Optionally, the preset behavior recognition model may further include: a lack-of-money recognition model (correspondingly identifying a lack-of-money status and a lack-of-money degree of a user), an uncivil-behavior recognition model (where for an uncivil behavior, a behavior recognition model is correspondingly generated for identification), an adverse-speech-publishing behavior recognition model (correspondingly identifying a behavior such as malicious advertiser, fraud, and fake information publishing), and the like. It should be noted that, the foregoing only lists optional forms of the behavior recognition model. Specifically, the form of the behavior recognition model may be added and adjusted according to an actual situation.

It should be noted that step S11 to step S13 may be considered as an implementation of determining, with reference to the preset behavior description corresponding to each behavior type and each behavior recognition model, the target behavior type corresponding to the obtained behavior information of the user. During actual application, in this embodiment, the target behavior type corresponding to the obtained behavior information of the user may alternatively be determined by using only the preset behavior description corresponding to each behavior type (for example, after new behavior information of the user is obtained, the behavior information and the preset behavior description corresponding to each behavior type may be matched, to determining the target behavior type matching the behavior information). In a possible implementation, in this embodiment, the target behavior type corresponding to the obtained behavior information of the user may alternatively be determined by using only the behavior recognition model (for example, after new behavior information of the user is obtained, the target behavior type corresponding to the behavior information may be identified according to the preset behavior recognition model). All of these means may be considered as implementations of determining the target behavior type corresponding to the obtained behavior information.

Optionally, in this embodiment, if the target behavior type corresponding to the obtained behavior information is not identified according to each behavior recognition model or the preset behavior description corresponding to the behavior type, it indicates that the obtained behavior information does not belong to the behavior type processed in this embodiment. Therefore, the procedure in this embodiment may be ended.

Step S14. The processing server obtains a credit score of the user.

Optionally, the user may be a user to which the obtained new behavior information belongs. Specifically, the new behavior information obtained by the processing server may include the user identifier, and the user may perform determining by using the user identifier.

Optionally, if the user uses, for the first time, the solution provided in this embodiment to adjust the credit score, or adjust the credit score for the first time, the processing server may recall a credit score of the user from a credit reporting platform (for example, from a bank credit reporting platform or a third-party credit reporting platform) as the credit score of the user. If the user has used the solution provided in this embodiment to adjust the credit score, the processing server may recall, from a local credit reporting database communicating with the processing server, a recorded credit score corresponding to the user (where the credit reporting database may record a credit score of each user, and adjust the recorded credit score by using the solution provided in this embodiment), as the credit score of the user.

Optionally, step S14 may be performed after step S10 is performed. When obtaining the new behavior information of the user, step S14 is not necessarily performed after step S11 to step S13 are performed.

Step S15. The processing server determines, according to a probability distribution for a credit adjustment score corresponding to each behavior type and each benchmark score, a target probability distribution by using the credit score of the user as a target reference score.

The target reference score may be the obtained credit score of the user. The target probability distribution may be a probability distribution for a credit adjustment score corresponding to the target behavior type and the target reference score. The target probability distribution may include a probability corresponding to adjustment from the credit score of the user to each credit adjustment score.

Optionally, in this embodiment, each credit score in a credit score range may be used as a benchmark score, so that a probability corresponding to each credit adjustment score to which each benchmark score may be adjusted in a case of each behavior type may be continuously updated by monitoring the behavior information of the user, to obtain and record the probability distribution for the credit adjustment score corresponding to each behavior type and each benchmark score. It may be understood that, for a behavior type and a benchmark score, the corresponding probability distribution includes a probability corresponding to the adjustment from the benchmark score adjust to each credit adjustment score in a case of the behavior type. That is, in the probability distribution, an event of adjustment from the benchmark score adjust to one of the credit adjustment scores corresponds to one probability. Therefore, a quantity of probabilities in the probability distribution corresponds to a quantity of credit adjustment scores to which the benchmark score may be adjusted.

Optionally, for example, the credit score range generally is integers from 0 to 999. A credit score 500 in the credit score range may be used as a benchmark score in this embodiment. In addition, a probability corresponding to the adjustment from the benchmark score to each credit adjustment score in each behavior type is defined, to obtain a probability distribution for a credit adjustment score corresponding to the behavior type and the benchmark score 500. Such processing is performed on each score in 0, . . . , 501, 502, . . . , and 999 in the credit score range, to obtain the probability distribution for the credit adjustment score corresponding to each behavior type and each benchmark score.

The credit score range shown above is integers from 0 to 999, and neighboring scores have a difference of 1. However, in an actual situation, in this embodiment, an interval value of the neighboring scores may be set to a set value. For example, the set value is not necessarily 1, but may be adjusted according to an actual situation, for example, set to be an integer greater than or equal to 1. Using neighboring scores having an interval value (set value) of 2 as an example, the credit score range is even numbers from 2 to 998.

Optionally, a credit adjustment score to which a benchmark score may be adjusted may cover the credit score range. That is, a limit value of a credit score adjustment is not limited in this embodiment. Any value within the credit score range may be adjusted to through one time of credit score adjustment, and specifically, may be determined according to a credit score that is considered as benchmark score and a probability corresponding to each credit adjustment score.

In addition, optionally, a credit adjustment score affected by one user behavior needs to be limited. In this embodiment, a value of one time of credit score adjustment may be limited within a set adjustment range. For example, a maximum of 50 scores may be increased and a maximum of 50 scores may be decreased for one time of adjustment. In this case, when the probability distribution for the credit adjustment score corresponding to each behavior type and each benchmark score is determined, in this embodiment, each credit score within the credit score range may be used as a benchmark score. For each benchmark score, a probability corresponding to each credit adjustment score that is in a corresponding set adjustment range and to which the benchmark score is adjusted in a case of each behavior type. That is, each credit adjustment score to which a benchmark score may be adjusted falls within a set adjustment range corresponding to the benchmark score. Correspondingly, each credit adjustment score to which the obtained credit score of the user may be adjusted also falls within a set adjustment range corresponding to the credit score of the user.

That the set adjustment range is from −m to m is used as an example, where m is a difference limit value of one time of credit score adjustment. For example, it is assumed that m is 50. In this case, in a case of a behavior type, a probability distribution for a credit adjustment score corresponding to a benchmark score n may be shown in FIG. 4, where a probability that the benchmark score is adjusted from n to n−m (using n scores as the benchmark score, a lowermost score for a time) is Pn−m, a probability that the benchmark score is adjusted from n to n−m+1 is Pn−m+1, . . . , a probability that the benchmark score is remained as n is Pn, . . . , a probability that the benchmark score is adjusted from n to n+m is Pn+m, and by analog. In addition, Σᵢ₌ₙ₋ₘ^{n+m} Pi=1, that is, in a case of a behavior type, for a probability distribution for a credit adjustment score corresponding to a benchmark score n, each probability is increased by 1 (100%).

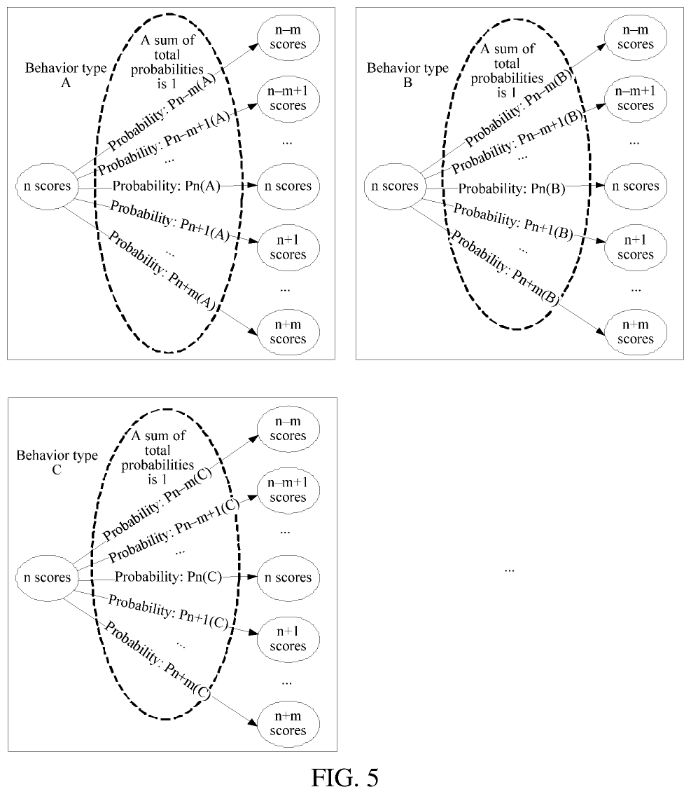

FIG. 4 shows in a case of a behavior type, a probability distribution for a credit adjustment score corresponding to a benchmark score n in a case of a behavior type. In this embodiment, there is a plurality of behavior types. Therefore, in various behavior types, the benchmark score n corresponds to probability distributions for credit adjustment scores. As shown in FIG. 5, in different cases of behavior types A, B, and C, probability distributions for credit adjustment scores corresponding to the benchmark score n are respectively corresponded to.

It is assumed that the credit score range is integers from 0 to 999, and there may be 1000 benchmark scores. A set adjustment range within which each benchmark score can be adjusted is from −m to m. In this case, a quantity of credit adjustment scores within a set adjustment range corresponding to a benchmark score is 2m+1. For a benchmark score, a quantity of probability values of a probability distribution corresponding to a behavior type is 2m+1, and a quantity of probability values of a probability distribution corresponding to all types is: a total quantity of behavior types*(2m+1). There may be values having a same probability, the values need to be distinguished. Correspondingly, for all benchmark scores, a quantity of probability values of a probability distribution corresponding to all types is: 1000*a total quantity of behavior types*(2m+1).

Optionally, a probability distribution for a credit adjustment score corresponding to each benchmark score in a case of a behavior type may be adjusted in real time according to behavior feedback of an executed behavior in the case of the behavior type that is monitored in real time, to ensure accuracy of the probability distribution for the credit adjustment score corresponding to each behavior type and each benchmark score, so that when obtaining the new behavior information of the user, the processing server can recall, according to the probability distribution for the credit adjustment score corresponding to each behavior type and each benchmark score, the probability distribution for the credit adjustment score corresponding to the target behavior type and the credit score of the user.

It should be noted that, updating the probability distribution and adjusting the credit score in real time are two branch procedures, and the probability distribution for the credit adjustment score corresponding to each behavior type and each benchmark score are a basis of adjusting the credit score of the user based on the obtained behavior information of the user.

Step S16. The processing server selects a target probability from the target probability distribution.

Optionally, in this embodiment, a random number generation rule may be preset. The random number generation rule may be used to generate a random number. The processing server may recall the random number generation rule to randomly generate a random number (a natural number from 0 to 1), and determine a probability corresponding to the random number in the target probability distribution, to obtain the target probability.

For ease of description, it is simply assumed that the probability distribution (that is, the target probability distribution) of the credit adjustment score corresponding to the target behavior type and the user the credit score is: a probability of adjustment to n1 is P1, a probability of adjustment to n2 is P2, a probability of adjustment to n3 is P3, and P1+P2+P3=1. In this case, after a random number is randomly generated, in this embodiment, a probability corresponding to a probability range to which the random number belongs may be determined, and the target probability may be determined in P1, P2, and P3. For example, the random number is 0.3, P1 is 0.2 (corresponding to a probability range of 0˜0.2), P2 is 0.6 (corresponding to a probability range of 0.2˜0.8), and P3 is 0.2 (corresponding to a probability range of 0.8˜1). In this case, it may be determined that a probability corresponding to the probability range (0.2˜0.8) to which the random number 0.3 belongs is 0.6, and determined that P2 is the target probability.

Optionally, for each credit adjustment score in the target probability distribution, a probability range corresponding to a probability of the credit adjustment score may be a range corresponding to an upper probability limit of a previous credit adjustment score of the credit adjustment score to a sum of the upper probability limit and the probability of the credit adjustment score.

For example, for credit adjustment scores for which n1, n2, and n3 are continuously increased, if the random number <P1, it is determined that the target probability is P1. If P1≤ the random number <P1+P2, it is determined that the target probability is P2. If P1+P2≤ the random number <P1+P2+P3, it is determined that the target probability is P3. For example, a probability range corresponding to P2 (the probability being 0.6) in the probability distribution may be a range corresponding to an upper probability limit 0.2 of a previous credit adjustment score n1 to the upper probability limit 0.2+a probability 0.6 of P2=0.8, namely, a probability range from 0.2 to 0.8.

Step S17. The processing server uses a credit score that corresponds to the target probability in the target probability distribution as an adjusted credit score.

Optionally, the foregoing manner of selecting the target probability from the target probability distribution by using the random number, to use the credit score corresponding to the target probability in the probability distribution as the adjusted credit score is only optional. Alternatively, this may be considered as an implementation of randomly selecting an adjusted credit score from the credit adjustment scores according to the probability that corresponds to the adjustment from the credit score of the user to each credit adjustment score and that is indicated by the target probability distribution.

Certainly, in addition to randomly selecting the adjusted credit score from the credit adjustment scores, in this embodiment, a probability corresponding to each credit adjustment score to which the credit score used as the benchmark score may further be substituted into a preset priority calculation formula (for the formula, in addition to the probability corresponding to each credit adjustment score, a difference between each credit adjustment score and the credit score used as the benchmark score may further be considered, and a specific calculation rule for the formula may be set according to an actual requirement), to calculate a selection priority of each credit adjustment score, and select a credit adjustment score having a highest priority as the adjusted credit score.

Obviously, all of the foregoing manners of determining the adjusted credit score may be considered as optional manners of determining, by the processing server, the adjusted credit score according to the probability that corresponds to the adjustment from the credit score of the user to each credit adjustment score and that is indicated by the probability distribution.

In certain aspects of this disclosure, the processing server may obtain the behavior information of the user; determine the target behavior type corresponding to the behavior information; obtain the credit score of the user; determine, according to the probability distribution for the credit adjustment score corresponding to each behavior type and each benchmark score, the target probability distribution by using the credit score of the user as the target reference score, the target probability distribution being a probability distribution for a credit adjustment score corresponding to the target behavior type and the target reference score, and the target probability distribution including a probability corresponding to adjustment from the credit score of the user to each credit adjustment score; and determine the adjusted credit score according to the probability that corresponds to the adjustment from the credit score of the user to each credit adjustment score and that is indicated by the target probability distribution, thereby obtaining the behavior information of the user in real time, adjusting the credit score of the user in real time, and improving timeliness of adjusting a credit score.

It should be noted that, different from a conventional manner in which multidimensional information is used as an input of the credit scoring model to adjust the credit score, in this embodiment, when obtaining the new behavior information of the user in real time, according to a target behavior type of the obtained behavior information and the credit score of the user, the probability corresponding to the adjustment from the credit score of the user to each credit adjustment score in the case of the target behavior type is obtained, thereby determining the adjusted credit score according to the probability corresponding to each credit adjustment score. Herein, this embodiment does not relate to input of multidimensional information as a credit scoring model. Instead, the obtained target behavior type of the behavior information is only determined, and according to the target behavior type, the credit score of the user, and the probability distribution for the credit adjustment score corresponding to each behavior type and each benchmark score, the probability of the adjustment from the credit score of the user to each credit adjustment score is determined, so that a credit score adjustment result obtained according to the probability is more targeted, and a scenario of monitoring the credit score adjustment is more applicable for a single behavior.

Optionally, after determining the adjusted credit score of the user, the credit adjustment score of the user may be correspondingly applied to fields such as credit and loan, sharing economy, user comments, and information recommendation. For example, an amount of credit of the user is adjusted according to the adjusted credit score of the user. For another example, information (for example, different credit reporting levels corresponding to different recommendation information, and different credit reporting levels corresponding to credit scores within different value ranges) corresponding to the adjusted credit score of the user is recommended according to the adjusted credit score of the user.

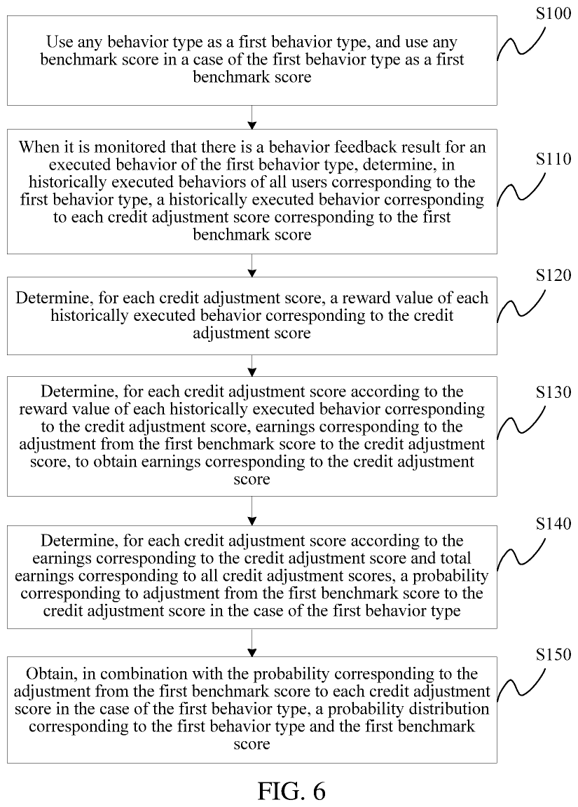

Optionally, the probability distribution for the credit adjustment score corresponding to each behavior type and each benchmark score may be adjusted in real time according to behavior feedbacks of all users that are monitored in real time. For ease of description, that a probability distribution for a credit adjustment score corresponding to a benchmark score in a case of a behavior type is adjusted in real time is used as an example. FIG. 6 is a flowchart of a probability distribution adjustment method. It should be noted that, the probability distribution for the credit adjustment score corresponding to each behavior type and each benchmark score may be adjusted by using the method shown in FIG. 6. FIG. 6 describes only a case of a benchmark score in a case of one behavior type.

The method shown in FIG. 6 may be performed by a processing server. Referring to FIG. 6, the method may include the following steps.

Step S100. Use any behavior type as a first behavior type, and use any benchmark score in a case of the first behavior type as a first benchmark score.

Step S110. When it is found, through monitoring, that there is a behavior feedback result for an executed behavior of the first behavior type, determine, in historically executed behaviors of all users corresponding to the first behavior type, a historically executed behavior corresponding to each credit adjustment score corresponding to the first benchmark score.

After the user performs a behavior (the executed behavior) for which feedback needs to be performed, the user needs to perform corresponding behavior feedback within a future agreed time. For example, after raising a loan that needs to be paid back in future, the user needs to pay back the load within an agreed repayment time. Therefore, in a case of the first behavior type, executed behavior information that corresponds to a behavior feedback in future needs to be recorded in this embodiment, and whether the behavior feedback for the executed behavior information exists is determined by using the monitored new behavior information of the user.

The behavior feedback result for the executed behavior may be that corresponding behavior feedback is performed within an agreed time or that no corresponding behavior feedback is performed within an agreed time. For an executed behavior of raising a loan, a behavior feedback result may be that repayment is performed within an agreed repayment time or that no repayment is performed within an agreed repayment time (that is, repayment is overdue).

When any behavior type is used as the first behavior type, and it is found, through monitoring, that there is a behavior feedback result for the executed behavior in the case of the first behavior type, in this embodiment, any benchmark score in the case of the first behavior type may be used as the first benchmark score, so that processing shown in FIG. 6 is performed on the first benchmark score in the case of the first behavior type, thereby adjusting a probability distribution corresponding to the first benchmark score in the case of the first behavior type.

Optionally, each credit adjustment score corresponding to the first benchmark score may be a credit adjustment score within a set adjustment range corresponding to the first benchmark score, and a historically executed behavior corresponding to a credit adjustment score corresponding to the first benchmark score may be represented as a historically executed behavior according to which the first benchmark score is adjusted to the credit adjustment score in the case of the first behavior type. These historically executed behaviors trigger the adjustment from the first benchmark score to the credit adjustment score.

Optionally, for the first benchmark score, each credit adjustment score within the set adjustment range corresponding to the first benchmark score may be determined, thereby determining, in historically executed behaviors of the first behavior type of all users, a historically executed behavior corresponding to each credit adjustment score adjusted from the first benchmark score.

Step S120. Determine, for each credit adjustment score, a reward value of each historically executed behavior corresponding to the credit adjustment score.

Optionally, a reward value of an executed behavior may include a first value and a second value, a credit reporting level represented by the first value being higher than a credit reporting level represented by the second value. Optionally, a reward value of an executed behavior may be determined depending on whether a behavior feedback of the executed behavior is performed within an agreed time. If the behavior feedback of the executed behavior is monitored within the agreed time, the reward value of the executed behavior is set to the first value. If the behavior feedback of the executed behavior is not monitored within the agreed time, the reward value of the executed behavior is set to the second value.

Optionally, it is assumed that the reward value is reword. In this case, the first value may be −1, and the second value may be 1 (where obviously, alternatively, the first value may be 1, and the second value may be −1; a specific value may be adjusted according to an actual situation; and herein, values −1 and 1 are only optional). If the user does not pay off a loan within an agreed time after the user raises the loan, reword of a load raising behavior of the user may be set to 1. If the user pays off the load within an agreed time, reword of a load raising behavior of the user may be set to −1.

Step S130. Determine, for each credit adjustment score according to the reward value of each historically executed behavior corresponding to the credit adjustment score, earnings corresponding to the adjustment from the first benchmark score to the credit adjustment score, to obtain earnings corresponding to the credit adjustment score.

For a credit adjustment score within the set adjustment range corresponding to the first benchmark score, in this embodiment, earnings corresponding to the adjustment from the first benchmark score to the credit adjustment score may be determined according to the reward value of each corresponding historically executed behavior, to obtain earnings corresponding to the credit adjustment score. Such processing is performed for each credit adjustment score, to obtain earnings corresponding to each credit adjustment score corresponding to the first benchmark score.

It is assumed that the first benchmark score is s0, and nextₛ₁ is a credit adjustment score of the first benchmark score. In this case, earnings corresponding to adjustment from the first benchmark score s0 to the adjusted credit reporting score nextₛ₁ may be set to fₛ₀,nextₛ₁. A calculation formula of fₛ₀,nextₛ₁ may be expressed as:

$${f}_{s 0} , {next}_{s 1} = \vert \frac{{\sum }_{i = 1}^{k} {reword}_{i}}{k} \vert + \sqrt[2]{2 * \frac{log ( K )}{k}}$$

k being a total quantity of uses, K being a total quantity of times that the first benchmark score s0 is historically adjusted to the credit adjustment score nextₛ₁.

Such processing may be performed for each credit adjustment score, to obtain earnings corresponding to each credit adjustment score.

It can be learned that, for each credit adjustment score, in this embodiment, historical earnings corresponding to the credit adjustment score may be determined according to the reward value of each historically executed behavior corresponding to the credit adjustment score and the total quantity of uses (corresponding to the credit adjustment score a total quantity of uses corresponding to the historically executed behavior); and for each credit adjustment score, in this embodiment, estimated future earnings corresponding to the credit adjustment score may be determined according to the total quantity of uses and a total quantity of times that the first benchmark score is historically adjusted to the credit adjustment score, thereby determining, as the earnings corresponding to the adjustment from the first benchmark score to the credit adjustment score, a sum of historical earnings and estimated future earnings corresponding to a same credit adjustment score.

That is,

$$\vert \frac{{\sum }_{i = 1}^{k} {reword}_{i}}{k} \vert$$

may represent earnings (an average value of historical earnings of all users) for the historical adjustment from the first benchmark score s0 to the credit adjustment score nextₛ₁.

It is assumed that the first value of reword is −1, and the second value is 1. In this case, that

$$\vert \frac{{\sum }_{i = 1}^{k} {reword}_{i}}{k} \vert$$

is closer to 0 indicates that behavior feedbacks of executed behaviors of the historical adjustment from the first benchmark score to the credit adjustment score nextₛ₁ appropriately affect the credit reporting, and a distinguishing degree thereof is relatively low.

When

$$\vert \frac{{\sum }_{i = 1}^{k} {reword}_{i}}{k} \vert$$

is closer to 1, it indicates that behavior feedbacks of executed behaviors of the historical adjustment from the first benchmark score to the credit adjustment score nextₛ₁ may all affect the credit reporting result, and indicates that credit reporting statuses of users can be distinguished by using the behavior feedbacks of executed behaviors of the historical adjustment from the first benchmark score to the credit adjustment score nextₛ₁, and that probabilities corresponding thereto may be relatively large.

Step S140. Determine, for each credit adjustment score according to the earnings corresponding to the credit adjustment score and total earnings corresponding to all credit adjustment scores, a probability corresponding to adjustment from the first benchmark score to the credit adjustment score in the case of the first behavior type.

Optionally, the total earnings corresponding to all credit adjustment scores may be considered as a sum of earnings corresponding to each credit adjustment score. Optionally, when determining a probability corresponding to an adjustment from the first benchmark score to a credit adjustment score, in this embodiment, the probability may be determined by dividing earnings corresponding to the credit adjustment score by the total earnings corresponding to all credit adjustment scores. A specific formula may be shown as follows:

$${P}_{s 0} , {next}_{s 1} = \frac{{f}_{s 0} , {next}_{s 1}}{{\sum }_{j = 1}^{L} {f}_{s 0} , {next}_{sj}}$$

Pₛ₀,nextₛ₁ being considered as a probability of the adjustment from the first benchmark score s0 to the credit adjustment score nextₛ₁ in the case of the first behavior type, fₛ₀,nextₛⱼ being considered as earnings corresponding to a credit adjustment score nextₛⱼ, and L being the total quantity of (for example, a quantity of credit adjustment scores within the set adjustment range corresponding to the first benchmark score) credit adjustment scores corresponding to the first benchmark score.

Step S150. Obtain, in combination with the probability corresponding to the adjustment from the first benchmark score to each credit adjustment score in the case of the first behavior type, a probability distribution corresponding to the first behavior type and the first benchmark score.

Optionally, step S130 and step S140 shown in FIG. 6 may be considered as an optional implementation process of determining, for each credit adjustment score according to the reward value of each corresponding historically executed behavior, the probability corresponding to the adjustment from the first benchmark score to the credit adjustment score in the case of the first behavior type, to obtain the probability corresponding to the adjustment from the first benchmark score to each credit adjustment score in the case of the first behavior type.

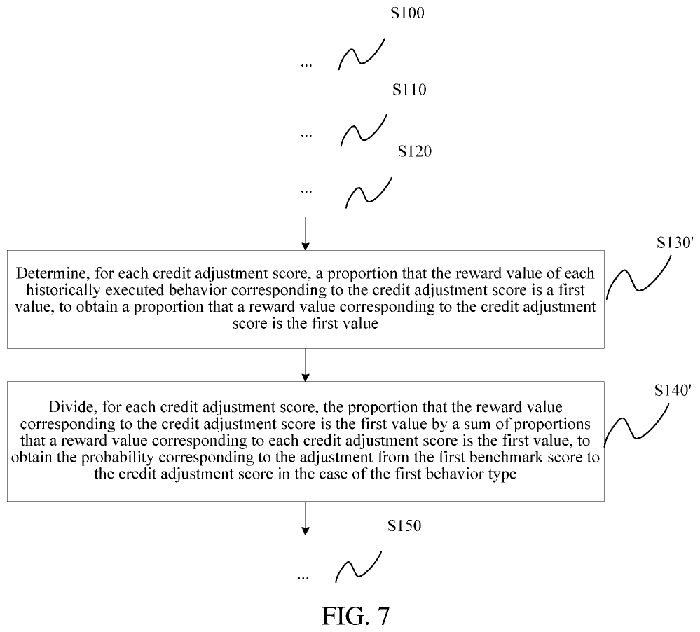

In addition to step S130 and step S140, in this embodiment, a manner shown in FIG. 7 may further be used for implementation. With reference to FIG. 6 and FIG. 7, when step S110 and step S120 shown in FIG. 6 are performed, for each credit adjustment score, after the reward value of the historically executed behavior corresponding to the credit adjustment score is determined, step S130 and step S140 shown in FIG. 6 may be replaced with the following steps shown in FIG. 7.

Step S130′. Determine, for each credit adjustment score, a proportion that the reward value of each historically executed behavior corresponding to the credit adjustment score is the first value, to obtain a proportion that a reward value corresponding to the credit adjustment score is the first value.

For each credit adjustment score, a reward value of an executed behavior may include a first value and a second value, a credit reporting level represented by the first value being higher than a credit reporting level represented by the second value. For a credit adjustment score, in this embodiment, a quantity of reward values, being the first value, of historically executed behaviors corresponding to the credit adjustment score may be determined, and a ratio of the determined quantity of reward values that are the first value to a total quantity of reward values of historically executed behaviors corresponding to the credit adjustment score is used as the proportion that the reward value of each historically executed behavior corresponding to the credit adjustment score is the first value.

For a credit adjustment score within the set adjustment range corresponding to the first benchmark score, a quantity of reward values of a corresponding historically executed behavior is 10000, and a quantity of first values is 6000. In this case, a proportion that a reward value corresponding to the credit adjustment score is the first value is 0.6.

Step S140′. Divide, for each credit adjustment score, the proportion that the reward value corresponding to the credit adjustment score is the first value by a sum of proportions that a reward value corresponding to each credit adjustment score is the first value, to obtain the probability corresponding to the adjustment from the first benchmark score to the credit adjustment score in the case of the first behavior type.

Optionally, it is assumed that in the case of the first behavior type, credit adjustment scores within the set adjustment range corresponding to the first benchmark score are n1, n2, and n3, and a proportion that a reward value corresponding to n1 is the first value is 0.6, a proportion that a reward value corresponding to n2 is the first value is 0.8, and a proportion that a reward value corresponding to n3 is the first value is 0.5.

In the case of the first behavior type, a probability corresponding to adjustment from the first benchmark score to n1 is 0.6/(0.6+0.8+0.5), and by analog. In this case, the probability corresponding to adjustment from the first benchmark score to each credit adjustment score in the case of the first behavior type can be obtained.

As shown in FIG. 6 and FIG. 7, when obtaining that there is a behavior feedback for an executed behavior of a behavior type, and determining a behavior feedback result, a probability distribution for a credit adjustment score corresponding to each benchmark score in the case of the behavior type is updated. Through continuous iterative update, accuracy of a probability distribution for a credit adjustment score corresponding to each benchmark score in a case of each behavior type is continuously improved.

Optionally, the foregoing manner of adjusting, in real time according to behavior feedbacks of all users that are monitored in real time, the probability distribution for the credit adjustment score corresponding to each behavior type and each benchmark score is only optional. In this embodiment, the probability distribution for the credit adjustment score corresponding to each behavior type and each benchmark score may be periodically adjusted based on collected user behaviors. After the accuracy of the probability distribution reaches a degree, a frequency of updating the probability distribution may be slowed.

Obviously, the foregoing described updating the probability distribution in a continuous self-learning iteration manner by monitoring the user behaviors is more preferable. However, this does not exclude a manner of manually marking, according to experience and an actual situation, the probability distribution for the credit adjustment score corresponding to each behavior type and each benchmark score.

Optionally, timing of adjusting the probability distribution may be not as strict as timing of adjusting the credit score in this embodiment. Certainly, the probability distribution may be updated in real time based on the monitored user behaviors when used in early stages and when an accuracy requirement is relatively high, to ensure that relatively high accuracy can be quickly obtained for the probability distribution through iteration.

It should further be noted that, if a behavior recognition model is used to identify the behavior type of the monitored behavior information, the behavior recognition model of each type needs to obtained by training corresponding positive and negative samples of corresponding types in advance by using a machine learning algorithm.

In a child presentation behavior recognition model, a behavior of presenting a child by a user may be identified by using a monitored moment shared by the user on an instant messaging platform. A training process of the child presentation behavior recognition model may be as follows: marking, in the moment shared by the user, a positive sample of a child presentation behavior and a negative sample of a non-child presentation behavior, where the used positive and negative samples may be text and/or an image in the moment shared by the user, thereby training the positive and negative samples by using a machine learning algorithm, to obtain child presentation behavior recognition model (where the child presentation behavior recognition model may exist in a form of a classifier). Further, when a moment newly shared by the user is monitored (where alternatively, no behavior type corresponding to the newly shared moment may be matched by using a preset behavior description corresponding to each behavior type), the child presentation behavior recognition model may be used to identify whether text and/or an image in the newly shared moment is related to child presentation, thereby identifying a child presentation behavior.

Correspondingly, principles of training and identification processes of a love behavior recognition model and a marriage behavior recognition model may be the same as that of training and identification processes of the child presentation behavior recognition model, and reference may be made to each other.

For another example, a lack-of-money recognition model may be used to identify whether the user is currently in a lack-of-money status. When the new behavior information of the user is monitored (or when a behavior type corresponding to the new behavior information is not matched by using a behavior description corresponding to each preset behavior type), a lack-of-money recognition model that is trained in advance may be used to identify whether a user is in a lack-of-money status. A specific process may be: collecting a load of the user corresponding to the new behavior information on each financial platform (including a bank platform, a third-party payment platform having a credit granting function, and the like) and a credit line of each financial platform for the user; and calculating a lack-of-money degree of the user by using a formula exp((load−credit line)/credit line), where the load in the formula may be a total loan of the user on the financial platforms, and the credit line in the formula may be a total credit line the user of the user on the financial platforms. In addition, alternatively, the load and the corresponding credit line of the user on each financial platform may be respectively imported into exp ((load−credit line)/credit line), to calculate a lack-of-money degree of the user corresponding to each financial platform, and then an average value is used as a final lack-of-money degree of the user. It may be understood that, when the loan is equal to the credit line, the lack-of-money degree of the user is 1; when the loan is greater than the credit line, the lack-of-money degree of the user is greater than 1; and when the loan is less than the credit line, the lack-of-money degree of the user is less than 1. That is, an increase in the load leads to a large lack-of-money degree of the user. When the lack-of-money degree of the user is greater than a threshold, it may be considered that the user is in a lack-of-money status, and a behavior type that the user is in a lack-of-money status is output. Correspondingly, if the user is in a lack-of-money status, the credit score of the user is affected.

For still another example, in this embodiment, a behavior recognition model is trained for each uncivil behavior (such as abuse, agitation, and provocation) for identification. In the training process, corresponding positive and negative samples are obtained through training by using a machine learning algorithm. Using the uncivil behavior, the abuse, as an example, common abuse information in the collected shared moment (a moment, a chat record, or the like shared in a social circle) of the user may be used as a positive sample, and normal information is used as a negative sample. The positive and negative samples are trained by using the machine learning algorithm such as a random forest and a gradient boosting decision tree, to obtain a behavior recognition model for an abuse behavior. Further, when monitoring a new moment shared by the user, the behavior recognition model for the abuse behavior may be used for identification. If an identification result is abuse, it is considered that the user executes an abuse behavior through a newly published moment.

For still another example, a trained malicious-advertiser behavior recognition model may be used to determine whether a moment shared by the user includes a malicious advertiser; a trained fraud behavior recognition model may be used to determine whether a moment shared by the user is suspected of fraud; and a fake-information behavior recognition model may be used to determine the user whether a moment shared by the user includes fake information, a rumor, and the like. In this way, a behavior of the user of publishing an adverse speech is identified. In this process, if it is found that the user edits or forwards an adverse speech, it is considered that the user has a behavior of publishing an adverse speech.

The foregoing lists training of some types of behavior recognition models and a behavior identification process. It should be noted that, the foregoing descriptions are only for ease of understanding a principle and possible implementations of identifying a behavior type by using a behavior recognition model in this embodiment. For a specific behavior recognition model training process and a behavior identification process, adjustment and setting may be performed according to an actual situation.

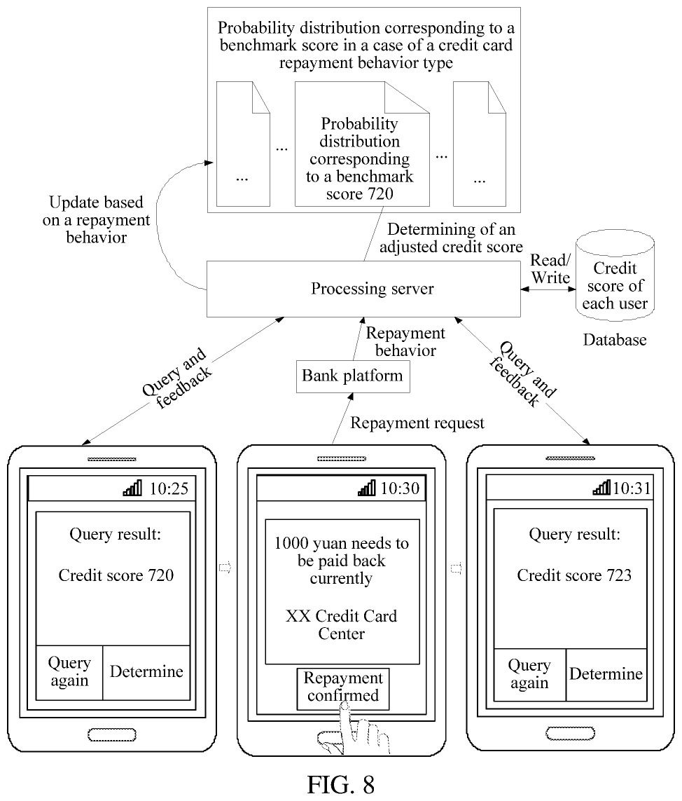

According to the method for processing credit score real-time adjustment provided in this embodiment, a credit score of a user may be adjusted in real time by monitoring new behavior information of the user in real time, thereby improving timeliness of adjusting the credit score of the user. FIG. 8 is a schematic application diagram according to aspects of certain embodiments.

If a credit score of a user is set to be visible to the user (or the credit score may be set to be invisible to the user, and herein that the credit score is visible to the user is used as an example), the user may query, on a credit reporting interface, the credit score of the user is 720. In this case, it is 10:25.

After the user performs credit card repayment by using a third-party payment client or a bank client at 10:30, assuming that a bank processes the repayment in real time, the processing server may monitor a credit card repayment behavior of the user by using a bank platform to which a credit card belongs, thereby identifying that a behavior type of the user is a credit card repayment type.

The processing server may recall a probability of each credit adjustment score to which a benchmark score 720 can be adjusted in a case of the credit card repayment type (that is, a probability distribution for a credit adjustment score corresponding to the credit card repayment type and the benchmark score 720), randomize a value, select, by using a probability corresponding to the value, an adjusted credit score from each credit adjustment score to which a benchmark score 720 can be adjusted, and update the credit score of the user by using the adjusted credit score. Assuming that the adjusted credit score is 723, the credit score of the user is updated to 723.

It is assumed that the processing server spends one minute in a process from monitoring the credit card repayment behavior of the user to updating the credit score of the user (where an actual time period may be short, herein is merely an example for ease of description, and a specific consumed time depends on performance of a network and a processing server). In this case, the user may query, at 10:31 on the credit reporting interface, that the credit score of the user is adjusted to 723. Compared with an existing manner of updating a credit score periodically such as every half a month, in this embodiment, timeliness of adjusting the credit score of the user is greatly improved. Correspondingly, for the loan part, an amount of credit of the user may be determined based on the credit score of the user that is adjusted in real time, thereby avoiding a decision failure. It should be noted that, the time described above is time within a same day.

Further, as shown in FIG. 8, the credit card repayment behavior of the user may also be used as a behavior feedback to update, in a case of the credit card repayment type, a probability distribution corresponding to each benchmark score, to continuously iterate a probability distribution corresponding to each benchmark score in a case of each behavior type, thereby improving accuracy of the probability distribution.

Obviously, if the credit score of the user is adjusted to 723, the processing server further adjust the credit score of the user in real time based on the monitored new behavior information of the user. In this process, the credit score of the user may further be improved or reduced.

In this embodiment, the probability distribution for the credit adjustment score corresponding to each benchmark score in a case of each behavior type is defined, so that the behavior information of the user that is monitored in real time is used as a credit score adjustment condition of the user to adjust the credit score of the user in real time, thereby improving timeliness of adjusting the credit score, and improving accuracy of subsequent application based on the credit score.

The following describes an apparatus for processing credit score real-time adjustment provided in an embodiment. The apparatus for processing credit score real-time adjustment described below may be considered as a functional module architecture disposed for implementing the method for processing credit score real-time adjustment provided in certain aspects of this disclosure, and content and the method content described above may refer to each other.

FIG. 9 is a structural block diagram of an apparatus for processing credit score real-time adjustment according to aspects of certain embodiments. The apparatus may be applied to a processing server. Referring to FIG. 9, the apparatus may include:

a behavior information obtaining module 100, configured to obtain behavior information of a user;

a behavior type determining module 200, configured to determine a target behavior type corresponding to the behavior information;

a user credit score obtaining module 300, configured to obtain a credit score of the user;

a probability distribution determining module 400, configured to determine, according to a probability distribution for a credit adjustment score corresponding to each behavior type and each benchmark score, a target probability distribution by using the credit score of the user as a target reference score, the target probability distribution being a probability distribution for a credit adjustment score corresponding to the target behavior type and the target reference score, and the target probability distribution including a probability corresponding to adjustment from the credit score of the user to each credit adjustment score; and

a credit score adjustment module 500, configured to determine an adjusted credit score according to the probability that corresponds to the adjustment from the credit score of the user to each credit adjustment score and that is indicated by the probability distribution.

Optionally, each credit adjustment score to which the credit score of the user is capable of being adjusted is in a set adjustment range corresponding to the credit score of the user.

Optionally, that the credit score adjustment module 500 is configured to determine an adjusted credit score according to the probability that corresponds to the adjustment from the credit score of the user to each credit adjustment score and that is indicated by the probability distribution specifically includes:

randomly select an adjusted credit score from the credit adjustment scores according to the probability that corresponds to the adjustment from the credit score of the user to each credit adjustment score and that is indicated by the probability distribution.

Optionally, that the credit score adjustment module 500 is configured to randomly select an adjusted credit score from the credit adjustment scores according to the probability that corresponds to the adjustment from the credit score of the user to each credit adjustment score and that is indicated by the probability distribution specifically includes:

generate a random number;

determine a probability that corresponds to the random number in the probability distribution, to obtain a target probability; and

use a credit score that corresponds to the target probability in the target probability distribution as the adjusted credit score.

Optionally, that the credit score adjustment module 500 is configured to determine a probability that corresponds to the random number in the probability distribution, to obtain a target probability specifically includes:

determine a probability range corresponding to a probability of each credit adjustment score in the target probability distribution, for each credit adjustment score, the probability range corresponding to the probability of the credit adjustment score being a range corresponding to an upper probability limit of a previous credit adjustment score of the credit adjustment score to a sum of the upper probability limit and the probability of the credit adjustment score; and determine a probability of a credit adjustment score corresponding to a probability range to which the random number belongs, to obtain the target probability.

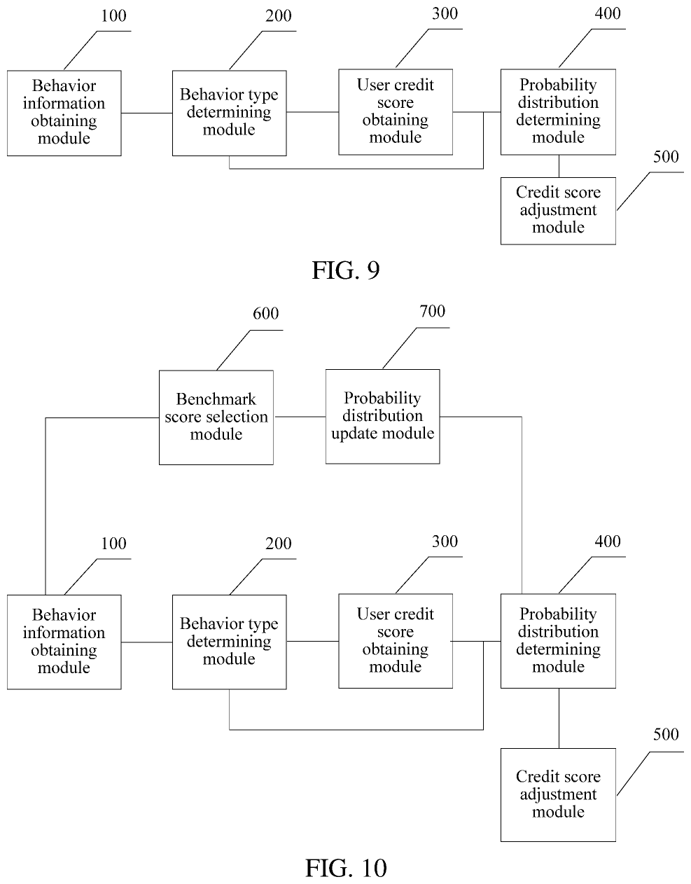

Optionally, FIG. 10 is another structural block diagram of an apparatus for processing credit score real-time adjustment according to aspects of certain embodiments. With reference to FIG. 9 and FIG. 10, the apparatus may further include:

a benchmark score selection module 600, configured to use each credit score in a credit score range as a benchmark score; and

a probability distribution update module 700, configured to update, according to the behavior information of the user, a probability corresponding to each credit adjustment score to which each benchmark score in a case of each behavior type is capable of being adjusted, and obtain and record a probability distribution for the credit adjustment score corresponding to each behavior type and each benchmark score.

Optionally, for a behavior type, specifically, a probability corresponding to each credit adjustment score to which a benchmark score can be adjusted may be updated in a case of the behavior type according to a behavior feedback result of an executed behavior of the behavior type, to obtain a probability distribution for a credit adjustment score corresponding to each behavior type and each benchmark score.

Optionally, that the probability distribution update module 700 is configured to update, according to the behavior information of the user, a probability corresponding to each credit adjustment score to which each benchmark score in a case of each behavior type is capable of being adjusted specifically includes:

use any behavior type as a first behavior type, and use any benchmark score in a case of the first behavior type as a first benchmark score;

when it is found, through monitoring, that there is a behavior feedback result for an executed behavior of the first behavior type, determine, in historically executed behaviors of all users corresponding to the first behavior type, a historically executed behavior corresponding to each credit adjustment score corresponding to the first benchmark score;

determine, for each credit adjustment score, a reward value of each historically executed behavior corresponding to the credit adjustment score, a value of the reward value including a first value and a second value, and a credit reporting level represented by the first value being higher than a credit reporting level represented by the second value; and

determine, for each credit adjustment score according to the reward value of each historically executed behavior corresponding to the credit adjustment score, a probability corresponding to adjustment from the first benchmark score to the credit adjustment score in a case of the first behavior type, to obtain a probability corresponding to adjustment from the first benchmark score to each credit adjustment score in the case of the first behavior type.

On one hand, optionally, that the probability distribution update module 700 is configured to determine, for each credit adjustment score according to the reward value of each historically executed behavior corresponding to the credit adjustment score, a probability corresponding to adjustment from the first benchmark score to the credit adjustment score in a case of the first behavior type includes:

determine, for each credit adjustment score according to the reward value of each historically executed behavior corresponding to the credit adjustment score, earnings corresponding to the adjustment from the first benchmark score to the credit adjustment score, to obtain earnings corresponding to the credit adjustment score; and

determine, for each credit adjustment score according to the earnings corresponding to the credit adjustment score and total earnings corresponding to all credit adjustment scores, the probability corresponding to adjustment from the first benchmark score to the credit adjustment score in the case of the first behavior type.

Optionally, that the probability distribution update module 700 is configured to determine, for each credit adjustment score according to the reward value of each historically executed behavior corresponding to the credit adjustment score, earnings corresponding to the adjustment from the first benchmark score to the credit adjustment score includes:

determine, for each credit adjustment score according to the reward value of each historically executed behavior corresponding to the credit adjustment score and a total quantity of users, historical earnings corresponding to the credit adjustment score; and determine, for each credit adjustment score according to a total quantity of times that the first benchmark score is historically adjusted to the credit adjustment score and the total quantity of users, estimated future earnings corresponding to the credit adjustment score; and

determine a sum of historical earnings and estimated future earnings corresponding to a same credit adjustment score, as earnings corresponding to adjustment from the first benchmark score to the credit adjustment score.

On the other hand, optionally, that the probability distribution update module 700 is configured to determine, for each credit adjustment score according to the reward value of each historically executed behavior corresponding to the credit adjustment score, a probability corresponding to adjustment from the first benchmark score to the credit adjustment score in a case of the first behavior type includes:

determine, for each credit adjustment score, a proportion that the reward value of each historically executed behavior corresponding to the credit adjustment score is the first value, to obtain a proportion that a reward value corresponding to the credit adjustment score is the first value; and

divide, for each credit adjustment score, the proportion that the reward value corresponding to the credit adjustment score is the first value by a sum of proportions that a reward value corresponding to each credit adjustment score is the first value, to obtain the probability corresponding to the adjustment from the first benchmark score to the credit adjustment score in the case of the first behavior type.

Optionally, that the behavior type determining module 200 is configured to determine a behavior type corresponding to the behavior information specifically includes:

match the behavior information with a preset behavior description corresponding to each behavior type, to determine whether a behavior type matching the behavior information exists; and

if a behavior type matching the behavior information exists, determine the behavior type matching the behavior information; or

if no behavior type matching the behavior information exists, identify, according to each preset behavior recognition model, a behavior type corresponding to the behavior information.

Optionally, on the other hand, that the behavior type determining module 200 is configured to determine a behavior type corresponding to the behavior information specifically includes:

match the behavior information with a preset behavior description corresponding to each behavior type, to determine a behavior type matching the behavior information; or

identify, according to each preset behavior recognition model, a behavior type corresponding to the behavior information.

Aspects of certain embodiments further provide a processing server. The processing server may include the apparatus for processing credit score real-time adjustment described above.

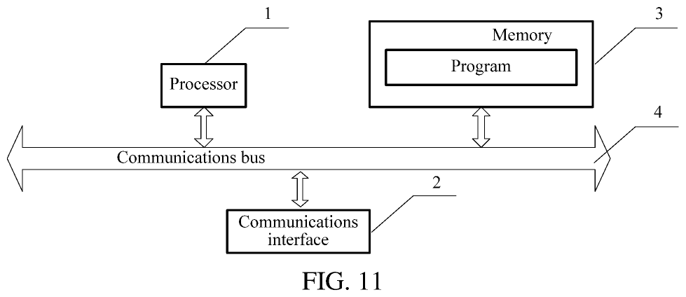

Optionally, FIG. 11 is a structural block diagram of hardware of the processing server. Referring to FIG. 11, the processing server may include at least one processor 1, at least one communications interface 2, at least one memory 3, and at least one communications bus 4. In this embodiment, the processing server includes at least one (one or more) processor 1, communications interface 2, memory 3, and communications bus 4. A form of communication between these components is not limited to that shown in FIG. 11. FIG. 11 shows only an optional hardware structure implementation of the processing server.

Optionally, in this embodiment, the processor 1, the communications interface 2, and the memory 3 communicate with each other by using the communications bus 4.

Optionally, the communications interface 2 may be an interface of a communications module, for example, an interface of a GSM module.

The processor 1 may be a central processing unit (CPU) or an application-specific integrated circuit (ASIC), or may be configured as one or more integrated circuits for implementing certain aspects of this disclosure.

The memory 3 may include a high-speed RAM memory, or may further include a non-volatile memory, for example, at least one magnetic disk memory. The processor 1 is specifically configured to obtain behavior information of a user; determine a target behavior type corresponding to the behavior information; obtain a credit score of the user; determine, according to a probability distribution for a credit adjustment score corresponding to each behavior type and each benchmark score, a target probability distribution by using the credit score of the user as a target reference score, the target probability distribution being a probability distribution for a credit adjustment score corresponding to the target behavior type and the target reference score, and the target probability distribution including a probability corresponding to adjustment from the credit score of the user to each credit adjustment score; and determine an adjusted credit score according to the probability that corresponds to the adjustment from the credit score of the user to each credit adjustment score and that is indicated by the probability distribution.

Optionally, the processor 1 is further specifically configured to adjust the credit score of the user using a credit adjustment score that is within a set adjustment range corresponding to the credit score of the user.

In a possible implementation of the first aspect, the determining an adjusted credit score according to the probability that corresponds to the adjustment from the credit score of the user to each credit adjustment score and that is indicated by the probability distribution includes: randomly selecting an adjusted credit score from the credit adjustment scores according to the probability that corresponds to the adjustment from the credit score of the user to each credit adjustment score and that is indicated by the probability distribution.

In a possible implementation of the first aspect, the randomly selecting an adjusted credit score from the credit adjustment scores according to the probability that corresponds to the adjustment from the credit score of the user to each credit adjustment score and that is indicated by the probability distribution includes: generating a random number; determining a probability that corresponds to the random number in the probability distribution, to obtain a target probability; and using a credit score that corresponds to the target probability in the target probability distribution as the adjusted credit score.

Optionally, the processor 1 is further specifically configured to: the determining a probability that corresponds to the random number in the probability distribution, to obtain a target probability includes: determining a probability range corresponding to a probability of each credit adjustment score in the target probability distribution, for each credit adjustment score, the probability range corresponding to the probability of the credit adjustment score being a range corresponding to an upper probability limit of a previous credit adjustment score of the credit adjustment score to a sum of the upper probability limit and the probability of the credit adjustment score; and determining a probability of a credit adjustment score corresponding to a probability range to which the random number belongs, to obtain the target probability.

Optionally, the processor 1 is further specifically configured to: use each credit score in a credit score range as a benchmark score; and update, according to the behavior information of the user, a probability corresponding to each credit adjustment score to which each benchmark score in a case of each behavior type is capable of being adjusted, and obtaining and recording a probability distribution for the credit adjustment score corresponding to each behavior type and each benchmark score.

Optionally, the processor 1 is further specifically configured to: the updating, according to the behavior information of the user, a probability corresponding to each credit adjustment score to which each benchmark score in a case of each behavior type is capable of being adjusted includes: using any behavior type as a first behavior type, and using any benchmark score in a case of the first behavior type as a first benchmark score; when it is found, through monitoring, that there is a behavior feedback result for an executed behavior of the first behavior type, determining, in historically executed behaviors of all users corresponding to the first behavior type, a historically executed behavior corresponding to each credit adjustment score corresponding to the first benchmark score; determining, for each credit adjustment score, a reward value of each historically executed behavior corresponding to the credit adjustment score, a value of the reward value including a first value and a second value, and a credit reporting level represented by the first value being higher than a credit reporting level represented by the second value; and determining, for each credit adjustment score according to the reward value of each historically executed behavior corresponding to the credit adjustment score, a probability corresponding to adjustment from the first benchmark score to the credit adjustment score in a case of the first behavior type, to obtain a probability corresponding to adjustment from the first benchmark score to each credit adjustment score in the case of the first behavior type.

Optionally, the processor 1 is further specifically configured to: the determining, for each credit adjustment score according to the reward value of each historically executed behavior corresponding to the credit adjustment score, a probability corresponding to adjustment from the first benchmark score to the credit adjustment score in a case of the first behavior type includes: determining, for each credit adjustment score according to the reward value of each historically executed behavior corresponding to the credit adjustment score, earnings corresponding to the adjustment from the first benchmark score to the credit adjustment score, to obtain earnings corresponding to the credit adjustment score; and determining, for each credit adjustment score according to the earnings corresponding to the credit adjustment score and total earnings corresponding to all credit adjustment scores, the probability corresponding to adjustment from the first benchmark score to the credit adjustment score in the case of the first behavior type.

Optionally, the processor 1 is further specifically configured to: the determining, for each credit adjustment score according to the reward value of each historically executed behavior corresponding to the credit adjustment score, earnings corresponding to the adjustment from the first benchmark score to the credit adjustment score includes: determining, for each credit adjustment score according to the reward value of each historically executed behavior corresponding to the credit adjustment score and a total quantity of users, historical earnings corresponding to the credit adjustment score; and determining, for each credit adjustment score according to a total quantity of times that the first benchmark score is historically adjusted to the credit adjustment score and the total quantity of users, estimated future earnings corresponding to the credit adjustment score; and determining a sum of historical earnings and estimated future earnings corresponding to a same credit adjustment score, as earnings corresponding to adjustment from the first benchmark score to the credit adjustment score.

Optionally, the processor 1 is further specifically configured to: the determining, for each credit adjustment score according to the reward value of each historically executed behavior corresponding to the credit adjustment score, a probability corresponding to adjustment from the first benchmark score to the credit adjustment score in a case of the first target behavior type includes: determining, for each credit adjustment score, a proportion that the reward value of each historically executed behavior corresponding to the credit adjustment score is the first value, to obtain a proportion that a reward value corresponding to the credit adjustment score is the first value; and dividing, for each credit adjustment score, the proportion that the reward value corresponding to the credit adjustment score is the first value by a sum of proportions that a reward value corresponding to each credit adjustment score is the first value, to obtain the probability corresponding to the adjustment from the first benchmark score to the credit adjustment score in the case of the first behavior type.

Optionally, the processor 1 is further specifically configured to: the determining a behavior type corresponding to the behavior information includes: matching the behavior information with a preset behavior description corresponding to each behavior type, to determine whether a behavior type matching the behavior information exists; and if a behavior type matching the behavior information exists, determining the behavior type matching the behavior information; or if no behavior type matching the behavior information exists, identifying, according to each preset behavior recognition model, a behavior type corresponding to the behavior information.

Optionally, the processor 1 is further specifically configured to: the determining a behavior type corresponding to the behavior information includes: matching the behavior information with a preset behavior description corresponding to each behavior type, to determine a behavior type matching the behavior information; or identifying, according to each preset behavior recognition model, a behavior type corresponding to the behavior information.

The processing server provided in this embodiment may adjust, based on the behavior information of the user that is monitored in real time, the credit score of the user in real time, thereby improving timeliness of adjusting a credit score.

An embodiment of this application further provides a storage medium, configured to store program code, the program code being used for performing any implementation in the method for processing credit score real-time adjustment according to the foregoing embodiments.

An embodiment of this application further provides a computer program product including instructions, the computer program product, when run on a computer, causing the computer to perform any implementation in the method for processing credit score real-time adjustment according to the foregoing embodiments.

It should be noted that the embodiments in this specification are all described in a progressive manner. Description of each of the embodiments focuses on differences from other embodiments, and reference may be made to each other for the same or similar parts among respective embodiments. The apparatus embodiments are substantially similar to the method embodiments and therefore are only briefly described, and reference may be made to the method embodiments for the associated part.

Persons skilled in the art may further realize that, in combination with the embodiments herein, units and algorithm, steps of each example described can be implemented with electronic hardware, computer software, or the combination thereof. In order to clearly describe the interchangeability between the hardware and the software, compositions and steps of each example have been generally described according to functions in the foregoing descriptions. Whether the functions are executed in a mode of hardware or software depends on particular applications and design constraint conditions of the technical solutions. Persons skilled in the art can use different methods to implement the described functions for each particular application, but it should not be considered that the implementation goes beyond the scope of the embodiments of the present disclosure.

In combination with the embodiments herein, steps of the method or algorithm described may be directly implemented using hardware, a software module executed by a processor, or the combination thereof. The software module may be placed in a random access memory (RAM), a memory, a read-only memory (ROM), an electrically programmable ROM (EPROM), an electrically erasable programmable ROM (EEPROM), a register, a hard disk, a removable magnetic disk, a CD-ROM, or any storage medium of other forms well-known in the technical field.

The above description of the disclosed embodiments enables persons skilled in the art to implement or use the present disclosure. Various modifications to these embodiments are understantable to persons skilled in the art, the general principles defined in the present disclosure may be implemented in other embodiments without departing from the core idea or scope of the present disclosure. Therefore, the present invention is not limited to these embodiments illustrated in the present disclosure, but needs to conform to the broadest scope consistent with the principles and novel features disclosed in the present disclosure.

What is claimed is:

1. A method for processing credit score real-time adjustment, performed by a processing server, and comprising:
obtaining behavior information of a user from at least one remote platform;
determining a target behavior type corresponding to the behavior information;
obtaining a credit score of the user;
determining, according to a probability distribution for a credit adjustment score corresponding to each behavior type and each benchmark score, a target probability distribution by using the credit score of the user as a target reference score, the target probability distribution being a probability distribution for a credit adjustment score corresponding to the target behavior type and the target reference score, and the target probability distribution comprising a probability corresponding to adjustment from the credit score of the user to each credit adjustment score;
determining an adjusted credit score according to the probability that corresponds to the adjustment from the credit score of the user to each credit adjustment score and that is indicated by the probability distribution; and
updating the credit score of the user based on the adjusted credit score.

2. The method for processing credit score real-time adjustment according to claim 1, wherein:
the determining an adjusted credit score comprises selecting an adjusted credit score from the credit adjustment scores according to the probability that corresponds to the adjustment from the credit score of the user to each credit adjustment score and that is indicated by the probability distribution;
the credit adjustment scores are in a set adjustment range corresponding to the credit score of the user; and
the selecting an adjusted credit score from the credit adjustment scores comprises:
generating a random number;
determining a probability that corresponds to the random number in the probability distribution, to obtain a target probability; and
using a credit score that corresponds to the target probability in the target probability distribution as the adjusted credit score.

3. The method for processing credit score real-time adjustment according to claim 2, wherein the determining a probability that corresponds to the random number in the probability distribution, to obtain a target probability comprises:
determining a probability range corresponding to a probability of each credit adjustment score in the target probability distribution, for each credit adjustment score, the probability range corresponding to the probability of the credit adjustment score being a range corresponding to an upper probability limit of a previous credit adjustment score of the credit adjustment score to a sum of the upper probability limit and the probability of the credit adjustment score; and
determining a probability of a credit adjustment score corresponding to a probability range to which the random number belongs, to obtain the target probability.

4. The method for processing credit score real-time adjustment according to claim 1, further comprising:
using each credit score in a credit score range as a benchmark score; and
updating, according to the behavior information of the user, a probability corresponding to each credit adjustment score to which each benchmark score in a case of each behavior type is capable of being adjusted, and obtaining and recording a probability distribution for the credit adjustment score corresponding to each behavior type and each benchmark score.

5. The method for processing credit score real-time adjustment according to claim 4, wherein the updating, according to the behavior information of the user, a probability corresponding to each credit adjustment score to which each benchmark score in a case of each behavior type is capable of being adjusted comprises:
using any behavior type as a first behavior type, and using any benchmark score in a case of the first behavior type as a first benchmark score;
when it is found, through monitoring, that there is a behavior feedback result for an executed behavior of the first behavior type, determining, in historically executed behaviors of all users corresponding to the first behavior type, a historically executed behavior corresponding to each credit adjustment score corresponding to the first benchmark score;
determining, for each credit adjustment score, a reward value of each historically executed behavior corresponding to the credit adjustment score, a value of the reward value comprising a first value and a second value, and a credit reporting level represented by the first value being higher than a credit reporting level represented by the second value; and
determining, for each credit adjustment score according to the reward value of each historically executed behavior corresponding to the credit adjustment score, a probability corresponding to adjustment from the first benchmark score to the credit adjustment score in a case of the first behavior type, to obtain a probability corresponding to adjustment from the first benchmark score to each credit adjustment score in the case of the first behavior type.

6. The method for processing credit score real-time adjustment according to claim 5, wherein the determining, for each credit adjustment score according to the reward value of each historically executed behavior corresponding to the credit adjustment score, a probability corresponding to adjustment from the first benchmark score to the credit adjustment score in a case of the first behavior type comprises:
determining, for each credit adjustment score according to the reward value of each historically executed behavior corresponding to the credit adjustment score, earnings corresponding to the adjustment from the first benchmark score to the credit adjustment score, to obtain earnings corresponding to the credit adjustment score; and
determining, for each credit adjustment score according to the earnings corresponding to the credit adjustment score and total earnings corresponding to all credit adjustment scores, the probability corresponding to adjustment from the first benchmark score to the credit adjustment score in the case of the first behavior type.

7. The method for processing credit score real-time adjustment according to claim 6, wherein the determining, for each credit adjustment score according to the reward value of each historically executed behavior corresponding to the credit adjustment score, earnings corresponding to the adjustment from the first benchmark score to the credit adjustment score comprises:
determining, for each credit adjustment score according to the reward value of each historically executed behavior corresponding to the credit adjustment score and a total quantity of users, historical earnings corresponding to the credit adjustment score; and determining, for each credit adjustment score according to a total quantity of times that the first benchmark score is historically adjusted to the credit adjustment score and the total quantity of users, estimated future earnings corresponding to the credit adjustment score; and
determining a sum of historical earnings and estimated future earnings corresponding to a same credit adjustment score, as earnings corresponding to adjustment from the first benchmark score to the credit adjustment score.

8. The method for processing credit score real-time adjustment according to claim 5, wherein the determining, for each credit adjustment score according to the reward value of each historically executed behavior corresponding to the credit adjustment score, a probability corresponding to adjustment from the first benchmark score to the credit adjustment score in a case of the first target behavior type comprises:
determining, for each credit adjustment score, a proportion that the reward value of each historically executed behavior corresponding to the credit adjustment score is the first value, to obtain a proportion that a reward value corresponding to the credit adjustment score is the first value; and
dividing, for each credit adjustment score, the proportion that the reward value corresponding to the credit adjustment score is the first value by a sum of proportions that a reward value corresponding to each credit adjustment score is the first value, to obtain the probability corresponding to the adjustment from the first benchmark score to the credit adjustment score in the case of the first behavior type.

9. The method for processing credit score real-time adjustment according to claim 1, wherein the determining a behavior type corresponding to the behavior information comprises:
matching the behavior information with a preset behavior description corresponding to each behavior type, to determine whether a behavior type matching the behavior information exists; and
if a behavior type matching the behavior information exists, determining the behavior type matching the behavior information; and
if no behavior type matching the behavior information exists, identifying, according to each preset behavior recognition model, a behavior type corresponding to the behavior information.

10. An apparatus for processing credit score real-time adjustment, comprising:
at least one memory configured to store computer program code;
at least one processor configured to access said computer program code and operate as instructed by said computer program code, said computer program code including:
behavior information obtaining code configured to cause the at least one processor to obtain behavior information of a user from at least one remote platform;
behavior type determining code configured to cause the at least one processor to determine a target behavior type corresponding to the behavior information;
user credit score obtaining code configured to cause the at least one processor to obtain a credit score of the user;
probability distribution determining code configured to cause the at least one processor to determine, according to a probability distribution for a credit adjustment score corresponding to each behavior type and each benchmark score, a target probability distribution by using the credit score of the user as a target reference score, the target probability distribution being a probability distribution for a credit adjustment score corresponding to the target behavior type and the target reference score, and the target probability distribution comprising a probability corresponding to adjustment from the credit score of the user to each credit adjustment score; and
credit score adjustment code configured to cause the at least one processor to determine an adjusted credit score according to the probability that corresponds to the adjustment from the credit score of the user to each credit adjustment score and that is indicated by the probability distribution, said credit adjustment score being in a set adjustment range corresponding to the credit score of the user, and to update the credit score of the user based on the adjusted credit score.

11. The apparatus for processing credit score real-time adjustment according to claim 10, wherein the credit score adjustment code is further configured to cause the at least one processor to randomly select an adjusted credit score from the credit adjustment scores according to the probability that corresponds to the adjustment from the credit score of the user to each credit adjustment score and that is indicated by the probability distribution.

12. The apparatus for processing credit score real-time adjustment according to claim 11, wherein the credit score adjustment code is further configured to cause the at least one processor to:
generate a random number;
determine a probability that corresponds to the random number in the probability distribution, to obtain a target probability; and
use a credit score that corresponds to the target probability in the target probability distribution as the adjusted credit score.

13. The apparatus for processing credit score real-time adjustment according to claim 12, wherein the credit score adjustment code is further configured to cause the at least one processor to:
determine a probability range corresponding to a probability of each credit adjustment score in the target probability distribution, for each credit adjustment score, the probability range corresponding to the probability of the credit adjustment score being a range corresponding to an upper probability limit of a previous credit adjustment score of the credit adjustment score to a sum of the upper probability limit and the probability of the credit adjustment score; and
determine a probability of a credit adjustment score corresponding to a probability range to which the random number belongs, to obtain the target probability.

14. The apparatus for processing credit score real-time adjustment according to claim 10, further comprising:
benchmark score selection code configured to cause the at least one processor to use each credit score in a credit score range as a benchmark score; and
probability distribution update code configured to cause the at least one processor to update, according to the behavior information of the user, a probability corresponding to each credit adjustment score to which each benchmark score in a case of each behavior type is capable of being adjusted, and obtain and record a probability distribution for the credit adjustment score corresponding to each behavior type and each benchmark score.

15. The apparatus for processing credit score real-time adjustment according to claim 14, wherein the probability distribution update code is configured to cause the at least one processor to:
use any behavior type as a first behavior type, and use any benchmark score in a case of the first behavior type as a first benchmark score;
when it is found, through monitoring, that there is a behavior feedback result for an executed behavior of the first behavior type, determine, in historically executed behaviors of all users corresponding to the first behavior type, a historically executed behavior corresponding to each credit adjustment score corresponding to the first benchmark score;
determine, for each credit adjustment score, a reward value of each historically executed behavior corresponding to the credit adjustment score, a value of the reward value comprising a first value and a second value, and a credit reporting level represented by the first value being higher than a credit reporting level represented by the second value; and
determine, for each credit adjustment score according to the reward value of each historically executed behavior corresponding to the credit adjustment score, a probability corresponding to adjustment from the first benchmark score to the credit adjustment score in a case of the first behavior type, to obtain a probability corresponding to adjustment from the first benchmark score to each credit adjustment score in the case of the first behavior type.

16. The apparatus for processing credit score real-time adjustment according to claim 15, wherein the probability distribution update code is configured to cause the at least one processor to:
determine, for each credit adjustment score according to the reward value of each historically executed behavior corresponding to the credit adjustment score, earnings corresponding to the adjustment from the first benchmark score to the credit adjustment score, to obtain earnings corresponding to the credit adjustment score; and
determine, for each credit adjustment score according to the earnings corresponding to the credit adjustment score and total earnings corresponding to all credit adjustment scores, the probability corresponding to adjustment from the first benchmark score to the credit adjustment score in the case of the first behavior type.

17. The apparatus for processing credit score real-time adjustment according to claim 16, wherein the probability distribution update code is configured to cause the at least one processor to:
determine, for each credit adjustment score according to the reward value of each historically executed behavior corresponding to the credit adjustment score and a total quantity of users, historical earnings corresponding to the credit adjustment score; and determine, for each credit adjustment score according to a total quantity of times that the first benchmark score is historically adjusted to the credit adjustment score and the total quantity of users, estimated future earnings corresponding to the credit adjustment score; and
determine a sum of historical earnings and estimated future earnings corresponding to a same credit adjustment score, as earnings corresponding to adjustment from the first benchmark score to the credit adjustment score.

18. The apparatus for processing credit score real-time adjustment according to claim 15, wherein the probability distribution update code is configured to cause the at least one processor to:
determine, for each credit adjustment score, a proportion that the reward value of each historically executed behavior corresponding to the credit adjustment score is the first value, to obtain a proportion that a reward value corresponding to the credit adjustment score is the first value; and
divide, for each credit adjustment score, the proportion that the reward value corresponding to the credit adjustment score is the first value by a sum of proportions that a reward value corresponding to each credit adjustment score is the first value, to obtain the probability corresponding to the adjustment from the first benchmark score to the credit adjustment score in the case of the first behavior type.

19. The apparatus for processing credit score real-time adjustment according to claim 10, wherein the behavior type determining code is configured to cause the at least one processor to:
match the behavior information with a preset behavior description corresponding to each behavior type, to determine whether a behavior type matching the behavior information exists; and
if a behavior type matching the behavior information exists, determine the behavior type matching the behavior information; and
if no behavior type matching the behavior information exists, identify, according to each preset behavior recognition model, a behavior type corresponding to the behavior information.

20. A non-transitory computer readable memory having stored thereon computer program code that when executed causes a computer to:
obtain behavior information of a user from at least one remote platform;
determine a target behavior type corresponding to the behavior information;
obtain a credit score of the user;
determine, according to a probability distribution for a credit adjustment score corresponding to each behavior type and each benchmark score, a target probability distribution by using the credit score of the user as a target reference score, the target probability distribution being a probability distribution for a credit adjustment score corresponding to the target behavior type and the target reference score, and the target probability distribution comprising a probability corresponding to adjustment from the credit score of the user to each credit adjustment score;
determine an adjusted credit score according to the probability that corresponds to the adjustment from the credit score of the user to each credit adjustment score and that is indicated by the probability distribution; and
update the credit score of the user based on the adjusted credit score.
